(19) United States
(12) Patent Application Publication
(10) Pub. No.: US 2006/0082317 A1
(43) Pub. Date: Apr. 20, 2006

(54) Electron-emitting apparatus

(75) Inventors: Iwao Ohwada, Nagoya-City (JP); Takayoshi Akao, Nagoya-City (JP); Tetsuyuki Kameji, Ama-Gun (JP); Hirokazu Nakamura, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/235,678

(22) Filed: Sep. 26, 2005

(30) Foreign Application Priority Data
Oct. 14, 2004 (JP) 2004-300392
Feb. 15, 2005 (JP) 2005-038151

(51) Int. Cl. H05B 37/00

(52) U.S. Cl. 315/167

(57) ABSTRACT

An electron-emitting apparatus includes an element having a lower electrode, an emitter section composed of a dielectric material, and an upper electrode having a plurality of micro through holes: and a drive voltage applying circuit having a power supply and a circuit that applies a voltage generated by the power supply between the lower electrode and the upper electrode. In order to emit electrons accumulated in the emitter section, the power supply generates a voltage gradually increasing from a first voltage to a second voltage. In order to accumulate electrons In the emitter section, the power supply generates a voltage gradually decreasing from the second voltage to the first voltage. A rapid change in element voltage and excessive element current can thereby be avoided, and unnecessary electron emission can be prevented.

### BACKGROUND OF THE INVENTION

1. Field of the Invention

The present invention relates to an electron-emitting apparatus including an emitter section composed of a dielectric material, a lower electrode disposed below the emitter section, and an upper electrode disposed above the emitter section.

2. Description of the Related Art

In the related art, an electron-emitting apparatus including an emitter section composed of a dielectric material, a lower electrode (lower electrode layer) disposed below the emitter section, and an upper electrode (upper electrode layer) disposed above the emitter section and having numerous micro trough holes has been known. According to this type of electron-emitting apparatus, a high-voltage pulse is applied between the upper electrode and the lower electrode to reverse the polarization of the dielectric material and to thereby emit electrons through the micro through holes in the upper electrode (e.g., refer to Japanese Patent No. 3160213, Claim 1, paragraphs 0016 to 0019, and FIGS. 2 and 3).

This type of apparatus is applicable to displays. For example, as shown in FIG. 40, the electron-emitting apparatus applied to a display includes a transparent plate 17, a collector electrode 18, and phosphors 19 above and opposing upper electrodes 14. In the electron-emitting apparatus, the phosphors 19 are irradiated with electrons emitted from an emitter section 13 through micro through holes (not shown) formed in the upper electrodes 14 and thereby emit light. A predetermined positive voltage is applied to the collector electrode 18 to thereby accelerate the emitted electrons.

Light emission caused by the electron emission is controlled as shown in FIG. 41, for example. In particular, from a time t10 to a time t20, the electron-emitting apparatus set a drive voltage Vin at a negative first voltage Vm. The drive voltage Vin is generated by the generated by a power supply and is applied between the upper electrode 14 and a lower electrode 12. As a result, the dipole in the emitter section 13 Is reversed (polarization reversal) and electrons are supplied from the upper electrode 14 to the emitter section 13. By this operation, the electrons are accumulated mainly in regions near the upper portion of the emitter section 13. Next, at the time t20, the drive voltage Vin is changed instantaneously from the first voltage Vm to a positive second voltage Vp to again reverse the polarization in the emitter section 13. As a result, electrons accumulated In the emitter section 13 are emitted in the upward direction by Coulomb repulsion caused by the polarization reversal. The phosphors 19 are thus irradiated with the electrons and emit light.

The electron-emitting apparatus repeats these operations. In other words, at the time t30, the drive voltage Vin is instantaneously changed from the second voltage Vp to the first voltage Vm to resume electron accumulation, and at the time t40, the drive voltage Vin is instantaneously changed from the first voltage Vm to the second voltage Vp to again emit electrons to emit light. In this manner, in the conventional electron-emitting apparatus, rectangular pulses are applied between the lower and upper electrode to repeat electron accumulation and electron emission.

### SUMMARY OF THE INVENTION

The inventors have found that, immediately after the time t30 (the time at which the drive voltage Vin is set at the positive second voltage Vp for electron accumulation) and immediately after the time t40 (the time at which the drive voltage Vin is set at the positive second voltage Vp for electron emission), unnecessary emission, such as electron emission at an unexpected timing and/or excessive electron emission that leads to abnormally intense light emission (extremely strong light emission) sometimes occurs.

The reason for this is unclear, however, may be due to the fact that, from the experiments, a large inrush current flows in the emitter section immediately after the switching of the drive voltage Vin and that the potential difference (hereinafter also referred to as “element voltage”) between the upper electrode and the lower electrode dramatically changes after completion of the polarization reversal in the emitter section. Emission of abnormally intense light is presumably caused by dielectric breakdown between the upper electrode 14 and the collector electrode 18 due to generation of plasma between the upper electrode 14 and the collector electrode 18. Once such intense light emission occurs, emission of abnormally intense light may continue due to continuation of the plasma state.

Unnecessary electron emission decreases the color purity and the contrast of the Images In the display. Moreover, emission of abnormally intense light sometimes scatters the materials that constitute the upper electrode 14 and destroy the upper electrode 14, or even pierces holes in the emitter section 13, thereby damaging the electron-emitting apparatus.

The present invention has been made to overcome the above-described problems. It is one of objects of the present invention to avoid unnecessary electron emission by appropriately controlling the voltage (drive voltage) generated by the power supply and/or the parameters of the circuit for applying the drive voltage.

To achieve the object, the present invention provides an electron-emitting apparatus including an element having an emitter section composed of a dielectric material, a lower electrode disposed below the emitter portion, and an upper electrode that is disposed above the emitter section to oppose the lower electrode with the emitter section therebetween, the upper electrode having a plurality of micro through holes; and drive voltage applying means having a power supply, and a circuit for applying a voltage, which is generated by the power supply, between the lower electrode and the upper electrode.

The power supply is configured to generate a first voltage to cause an element voltage to converge on a negative predetermined voltage so that electrons are supplied from the upper electrode to the emitter section and accumulated In the emitter section, and to generate subsequently a voltage which gradually increase toward a second voltage to cause the element voltage to converge on a positive predetermined voltage so that the electrons accumulated in the emitter section are emitted from the emitter section, the element voltage being a potential difference between the lower electrode and the upper electrode with respect to a potential of the lower electrode.

In the electron-emitting apparatus, the power supply generates a voltage which increases gradually when the element voltage is to be set at the positive predetermined voltage in order to emit electrons. Thus, the inrush current flowing in the emitter section immediately after the start of the voltage increase by the power supply can be smaller, and the rate of change in element voltage after completion of the positive-side polarization reversal can also be smaller. As a result, unnecessary electron emission (unnecessary light emission in case where a phosphor opposing the upper electrode is provided such as in a display) due to the inrush current and unnecessary electron emission (unnecessary light emission) due to the rapid change in element voltage immediately after the completion of the positive-side polarization reversal can be avoided.

Moreover, when the voltage (drive voltage) generated by the power supply is varied as described above, the polarization reversal and the electron emission are caused while the difference between the drive voltage and the element voltage is small. Thus, power consumption (generation of joule heat) by resistor components in the element and a region near the elements can be decreased. As a result, the element is not heated, and thus, the properties of the emitter section can be prevented from being changed by the heat. Besides, since the element temperature does not become high, evaporation of the materials adhering onto the element can be avoided. As a result, occurrence of plasma is avoided, and thus, excessive electron emission (intense light emission) as well as damage on the element by ion bombardment can be avoided.

Preferably, the power supply is configured such that, after generation of the first voltage, the power supply generates a voltage increasing from the first voltage to a third voltage so that the element voltage is caused to be an intermediate voltage between the negative predetermined voltage and the positive predetermined voltage, the intermediate voltage causing neither further electron accumulation in nor electron emission from the emitter section; and subsequently, the power supply generates a voltage increasing from the third voltage to the second voltage at a rate lower than a rate at which the voltage is increased from the first voltage to the third voltage.

Since the polarization reversal in the emitter section does not occur when the element voltage is set at the intermediate voltage, neither further electron accumulation in nor electron emission from the emitter section occurs. Furthermore, the unnecessary electron emission does not occur if the voltage generated by the power supply is caused to increase relatively rapidly while the element voltage is caused to vary from the negative predetermined voltage to the intermediate voltage. Accordingly, with the feature described above, the time required from the electron accumulation to the normal (designed, expected) electron emission can be shortened while avoiding unnecessary electron emission.

Preferably, the power supply is configured such that, within a period from a time point at which generation of the voltage gradually increasing toward the second voltage is started to a time point at which the voltage reaches the second voltage, the power supply generates a voltage that increases at a lowest rate during a period from the time point at which the generation of the voltage gradually increasing toward the second voltage is started to a time point at which positive-side polarization reversal in the emitter section is substantially completed.

The period from “the time point at which generation of the voltage gradually increasing toward the second voltage (from the first or third voltage) is started” to “the time point at which the voltage reaches the second voltage” is a period in which the inrush current flowing in the emitter becomes significantly large. Thus, by causing the voltage from the power supply to increase at the lowest rate as described above, it is possible to make the inrush current very small. As a result, unnecessary electron emission due to the inrush current can be avoided. Moreover, since the voltage can be gradually increased at a relatively high rate of change from “the time point at which the positive-side polarization reversal is completed” to “the time point at which the voltage from the power supply reaches the second voltage”, it is possible to shorten the voltage increasing period (the period in which a voltage operation to emit electrons is carried out) which is from the time point at which the voltage from the power supply is started to be increased and to the time point at which the voltage from the power supply reaches the second voltage.

Alternatively, the power supply is configured such that, within a period from a time point at which generation of the voltage gradually increasing toward the second voltage is started to a time point at which the voltage reaches the second voltage, the power supply generates a voltage that increases at a lowest rate during a period from a time point at which positive-side polarization reversal in the emitter section is substantially completed to the time point at which the voltage reaches the second voltage.

In some elements by themselves or other elements with some measures to avoid unnecessary electron emission, unnecessary electron emission due to a rapid change in the element voltage upon completion of the positive-side polarization reversal occurs more frequently than the unnecessary electron emission due to the inrush current. Thus, for such elements, unnecessary electron emission can be effectively avoided by increasing the voltage generated by the power supply at a lowest rate from the completion of the positive-side polarization reversal to the time point at which the voltage reaches the second voltage. Moreover, since the voltage generated by the power supply can be gradually increased at a relatively high rate during a period from the start of the voltage increase to the completion of the positive-side polarization reversal, it is possible to shorten the voltage Increasing period (the period in which a voltage operation to emit electrons is carried out) which is from the time point at which the voltage from the power supply is started to be increased and to the time point at which the voltage from the power supply reaches the second voltage.

The present invention also provides another electron-emitting apparatus comprising: an element including an emitter section composed of a dielectric material, a lower electrode disposed below the emitter portion, and an upper electrode that is disposed above the emitter section to oppose the lower electrode with the emitter section therebetween, the upper electrode having a plurality of micro through holes; and drive voltage applying means including a power supply and a circuit for applying a voltage, which is generated by the power supply, between the lower electrode and the upper electrode. The power supply is configured to generate a second voltage to cause an element voltage to converge on a positive predetermined voltage so that electrons accumulated in the emitter section is emitted from the emitter section, and to generate subsequently a voltage which gradually decrease toward a first voltage to cause the element voltage to converge on a negative predetermined voltage so that the electrons are supplied from the upper electrode to the emitter section and accumulated in the emitter section, the element voltage being a potential difference between the lower electrode and the upper electrode with respect to a potential of the lower electrode.

In this apparatus, the power supply generates a voltage which decreases gradually when the element voltage is to be set at the negative predetermined voltage in order to emit electrons. Thus, the inrush current flowing in the emitter section immediately after the voltage generated by the power supply starts to decrease can be smaller, and the rate of change in element voltage after completion of the negative-side polarization reversal can also be smaller. As a result, unnecessary electron emission (unnecessary light emission in case where a phosphor opposing the upper electrode is provided such as in a display) due to the inrush current and unnecessary electron emission (unnecessary light emission) due to the rapid change in element voltage immediately after the completion of the negative-side polarization reversal can be avoided.

Moreover, when the voltage (drive voltage) generated by the power supply is varied as described above, the polarization reversal and the electron emission are caused while the difference between the drive voltage and the element voltage is small. Thus, power consumption (generation of joule heat) by resistor components in the element and a region near the elements can be decreased. As a result, the element is not heated, and thus, the properties of the emitter section can be prevented from being changed by the heat. Besides, since the element temperature does not become high, evaporation of the materials adhering onto the element can be avoided. As a result, occurrence of plasma is avoided, and thus, excessive electron emission (intense light emission) as well as damage on the element by ion bombardment can be avoided.

Preferably, the power supply is configured such that, after generation of the second voltage, the power supply generates a voltage decreasing from the second voltage to a third voltage so that the element voltage is caused to be an intermediate voltage between the negative predetermined voltage and the positive predetermined voltage, the intermediate voltage causing neither electron accumulation in nor electron emission from the emitter section; and subsequently the power supply generates a voltage decreasing from the third voltage to the first voltage at a rate lower than a rate at which the voltage is decreased from the second voltage to the third voltage.

When the element voltage is set at the Intermediate voltage, neither further electron accumulation in nor electron emission from the emitter section occurs. Furthermore, the unnecessary electron emission does not occur if the voltage generated by the power supply is caused to increase relatively rapidly while the element voltage is caused to become the intermediate voltage. Accordingly, with the feature described above, the time required from the electron emission to the electron accumulation can be shortened.

Preferably, the power supply is configured such that, within a period from a time point at which generation of voltage gradually decreasing toward the first voltage is started to a time point at which the voltage reaches the first voltage, the power supply generates a voltage that decreases at a lowest rate during a period from the time point at which the generation of the voltage gradually decreasing toward the first voltage is started to a time point at which negative-side polarization reversal in the emitter section is substantially completed.

The period from “the time at which generation of the voltage gradually decreasing toward the first voltage (from the second or third voltage) is started” to “the time point of the substantial completion of the negative-side polarization reversal in the emitter section” is a period in which the inrush current flowing in the emitter becomes significantly large. Thus, by causing the voltage from the power supply to decrease at the lowest rate during this period as described above, it is possible to decrease the inrush current effectively. As a result, unnecessary electron emission due to the inrush current can be avoided. Moreover, since the voltage can be gradually decreased at a relatively high rate of change from “the completion of the negative-side polarization reversal” to “the time point at which the voltage generated by the power supply reaches the first voltage”, it is possible to shorten the voltage decreasing period (the period in which a voltage operation to accumulate electrons) which is from the time point at which the voltage from the power supply Is started to be decreased to the time point at which the voltage from the power supply reaches the first voltage.

Alternatively, the power supply may be configured such that, within a period from a time point at which generation of voltage gradually decreasing toward the first voltage is started to a time point at which the voltage reaches the first voltage, the power supply generates a voltage that decreases at a lowest rate during a period from a time point at which negative-side polarization reversal in the emitter section Is substantially completed to the time point at which the voltage reaches the first voltage.

In some elements by themselves or other elements with some measures to avoid unnecessary electron emission, unnecessary electron emission due to a rapid change in element voltage upon completion of the negative-side polarization reversal occurs more frequently than the unnecessary electron emission due to the inrush current. Thus, for such elements, unnecessary electron emission can be effectively avoided by decreasing the voltage generated by the power supply at a lowest rate from the completion of the negative-side polarization reversal to the time point at which the drive voltage reaches the first voltage. Moreover, since the voltage generated by the power supply can be gradually decreased at a relatively high rate from the start of the voltage decrease to the completion of the negative-side polarization reversal, It is possible to shorten the voltage decreasing period (the period in which a voltage operation to accumulate electrons) which is from the time point at which the voltage from the power supply is started to be decreased to the time point at which the voltage from the power supply reaches the first voltage.

When repeated electron emission is necessary as when the apparatus is applied to a display, the power supply is configured to repeat generation of the first voltage and the second voltage in an alternating manner.

Here, the drive voltage applying means preferably includes circuit parameter setting means for setting a circuit parameter of the circuit by connecting a circuit element to the circuit, the circuit element being selected from the following:

a first circuit element that connects to the circuit during a first period from a time point at which the generation of the voltage decreasing toward the first voltage is started to a time point at which the negative-side polarization reversal in the emitter section is substantially completed while the voltage is decreased,

a second circuit element that connects to the circuit during a second period from the time point at which the negative-side polarization reversal in the emitter section is substantially completed to a time point at which electron emission in the emitter section is completed,

a third circuit element that connects to the circuit during a third period from a time point at which generation of the voltage increasing toward the second voltage is started to a time point at which the positive-side polarization reversal in the emitter section is substantially completed while the voltage is increased, and

a fourth circuit element that connects to the circuit during a fourth period from a time point at which the positive-side polarization reversal is substantially completed to a time point at which electron emission from the emitter section is substantially completed. Here, it is preferable that at least two of these circuit elements be different from each other.

During each of the first, the second, the third, and the fourth periods, unnecessary electron emission can take place. However, the period in which unnecessary electron emission is frequent differs from one apparatus from another, depending on the characteristics of the element, the characteristics being determined by the materials and the like, and depending on other additional measures (such as controlling the collector electrode) for avoiding the unnecessary electron emission. In view of this, it is possible to avoid unnecessary electron emission by inserting (connecting) a selected circuit element into the circuit for connecting the power supply, the upper electrode, and the lower electrode so that the parameter of the circuit is constantly set at a high value.

However, such an arrangement requires a longer time for electron accumulation and electron emission, and thus, electron emission at a desired frequency (cycle) is no longer possible. Therefore, as in the above-described arrangement of the present invention, the circuit element (e.g., a resistor) to be inserted into (connected to) the circuit is selectively switched depending on the period so that the circuit parameter during the period in which the unnecessary electron emission occurs frequently due to the characteristics of the element is different from the circuit parameter during other periods. According to this arrangement, an electron-emitting apparatus which can emit electrons at a desired frequency while avoiding unnecessary electron emission is provided. In such a case, the above-described voltage control for gradually increasing or decreasing the voltage generated by the power supply may or may not be performed.

The present invention also provides another electron-emitting apparatus including an element having an emitter section composed of a dielectric material, a lower electrode disposed below the emitter portion, and an upper electrode that is disposed above the emitter section to oppose the lower electrode with the emitter section therebetween, the upper electrode having a plurality of micro through holes; and drive voltage applying means having a power supply, and a circuit for applying a voltage, which is generated by the power supply, between the lower electrode and the upper electrode.

Here, the power supply, in order to supply electrons from the upper electrode to the emitter section and to accumulate the electrons in the emitter section, is configured to generate a fourth voltage which is a negative voltage to cause polarization reversal in the emitter section, then to generate a fifth voltage, which is a negative voltage whose absolute value is smaller than the absolute value of the fourth voltage, at a time point at which the polarization reversal is substantially completed or before the completion of the polarization reversal, and then to generate a voltage which gradually decreases toward a first voltage and which is a negative voltage whose absolute value is larger than the absolute value of the fifth voltage.

According to experiments, unnecessary electron emission is frequently observed upon completion of the negative-side polarization reversal that causes a rapid change in element voltage. Thus, by controlling the voltage generated by the power supply as described above, the difference between the element voltage and the voltage generated by the power supply after the negative-side polarization reversal decreases, and this causes the element voltage to change gradually with the voltage generated by the power supply. Thus, the frequency of the unnecessary electron emission can be reduced. Moreover, since the voltage generated by the power supply until occurrence of the negative-side polarization reversal is set to the fourth voltage, which is the negative voltage whose absolute value is larger than that of the fifth voltage, the time taken until the negative-side polarization reversal can be shortened.

### BRIEF DESCRIPTION OF THE DRAWINGS

FIG. 1 is a partial cross-sectional view of an electron-emitting apparatus according to a first embodiment of the present invention;

FIG. 2 is a partial cross-sectional view of the electron-emitting apparatus shown in FIG. 1, taken along a different plane;

FIG. 3 is a partial plan view of the electron-emitting apparatus shown in FIG. 1;

FIG. 4 Is an enlarged partial cross-sectional view of the electron-emitting apparatus shown in FIG. 1;

FIG. 5 is an enlarged partial plan view of an upper electrode shown in FIG. 1;

FIG. 6 shows a state of the electron-emitting apparatus shown in FIG. 1;

FIG. 7 is a graph indicating the voltage-polarization characteristic of an emitter section shown in FIG. 1;

FIG. 8 is a time chart for explaining the operation principle of the electron-emitting apparatus shown in FIG. 1;

FIG. 9 shows yet another state of the electron-emitting apparatus shown in FIG. 1;

FIG. 10 shows yet another state of the electron-emitting apparatus shown In FIG. 1;

FIG. 11 shows still another state of the electron-emitting apparatus shown in FIG. 1;

FIG. 12 shows another state of the electron-emitting apparatus shown in FIG. 1;

FIG. 13 shows yet another state of the electron-emitting apparatus shown in FIG. 1;

FIG. 14 is a diagram showing electron emission from an electron-emitting apparatus having no focusing electrode;

FIG. 15 is a diagram showing electron emission from the electron-emitting apparatus shown in FIG. 1;

FIG. 16 is a time chart showing the drive voltage, element voltage, element current, and optical output of a conventional electron-emitting apparatus during normal electron emission;

FIG. 17 Is a time chart showing the drive voltage, element voltage, element current, and optical output of a conventional electron-emitting apparatus during unnecessary (abnormal) electron emission;

FIG. 18 is a time chart showing the drive voltage, element voltage, element current, and optical output of a conventional electron-emitting apparatus during unnecessary (abnormal) electron emission;

FIG. 19 is a time chart showing the drive voltage, element voltage, element current, and optical output of a conventional electron-emitting apparatus during unnecessary (abnormal) electron emission;

FIG. 20 is a time chart showing the drive voltage, element voltage, and element current when the waveform of the drive voltage is changed;

FIG. 21 is a time chart showing the drive voltage, element voltage, and element current when the waveform of the drive voltage is changed;

FIG. 22 is a time chart showing the drive voltage, element voltage, element current, and optical output of the electron-emitting apparatus shown in FIG. 1;

FIG. 23 is a circuit diagram of a drive voltage applying circuit, a focusing electrode potential applying circuit, and a collector voltage applying circuit shown in FIG. 1;

FIG. 24 is a time chart showing the drive voltage and element voltage of an electron-emitting apparatus according to a second embodiment of the present invention;

FIG. 25 Is a time chart showing the drive voltage and element voltage of an electron-emitting apparatus according to a third embodiment of the present invention;

FIG. 26 is a time chart showing the drive voltage and element voltage of an electron-emitting apparatus according to a fourth embodiment of the present invention;

FIG. 27 is a circuit diagram of an electron-emitting apparatus according to a fifth embodiment of the present invention:

FIG. 28 Is a time chart showing the drive voltage of the electron-emitting apparatus shown in FIG. 27;

FIG. 29 is a time chart showing the drive voltage, element voltage, element current, and optical output of an electron-emitting apparatus according to a sixth embodiment of the present invention;

FIG. 30 is a circuit diagram of an electron-emitting apparatus according to a seventh embodiment of the present invention;

FIG. 31 is a time chart for explaining the operation of the electron-emitting apparatus shown in FIG. 30;

FIG. 32 Is a partial cross-sectional view of an electron-emitting apparatus according to an eighth embodiment of the present invention;

FIG. 33 is a partial plan view of a modification example of the electron-emitting apparatus of the present invention;

FIG. 34 is a partial plan view of another modification example of the electron-emitting apparatus of the present invention;

FIG. 35 is a partial cross-sectional view of another modification example of the electron-emitting apparatus of the present invention;

FIG. 36 is another partial cross-sectional view of the electron-emitting apparatus shown in FIG. 35;

FIG. 37 is a circuit diagram of a measurement circuit for determining the relationship between the rising time of the drive voltage and the amount of the electrons emitted:

FIG. 38 is a time chart showing changes in collector current and output voltage from an optical output measuring device when the drive voltage is varied;

FIG. 39 is a graph showing the relationship between the amount of emitted electrons and the intensity of the light output from the optical output measuring device plotted versus the rising time of the drive voltage varied in various manners;

FIG. 40 is a partial cross-sectional view of an electron-emitting apparatus outside the range of the present Invention; and

FIG. 41 is a time chart showing the drive voltage, collector voltage, and optical output of the electron-emitting apparatus shown in FIG. 40.

### DESCRIPTION OF THE PREFERRED EMBODIMENTS

Electron-emitting apparatuses according to the preferred embodiments of the present invention will now be described with reference to the drawings. The electron-emitting apparatus is applicable to electron beam irradiators, light sources, manufacturing apparatuses for electronic components, and the like. In the description below, the electron-emitting apparatuses are applied to displays.

### First Embodiment

Structure

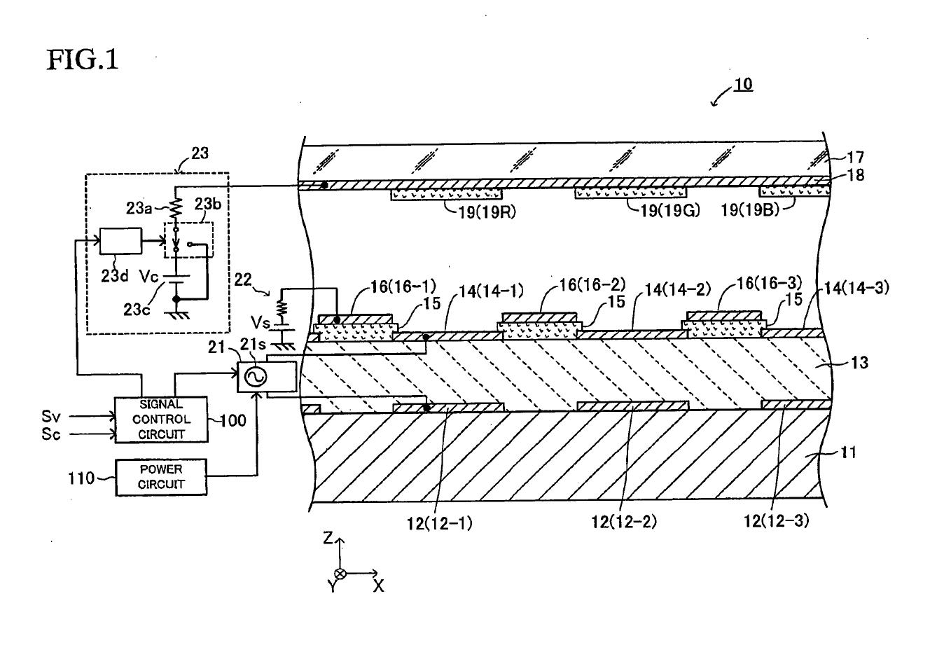

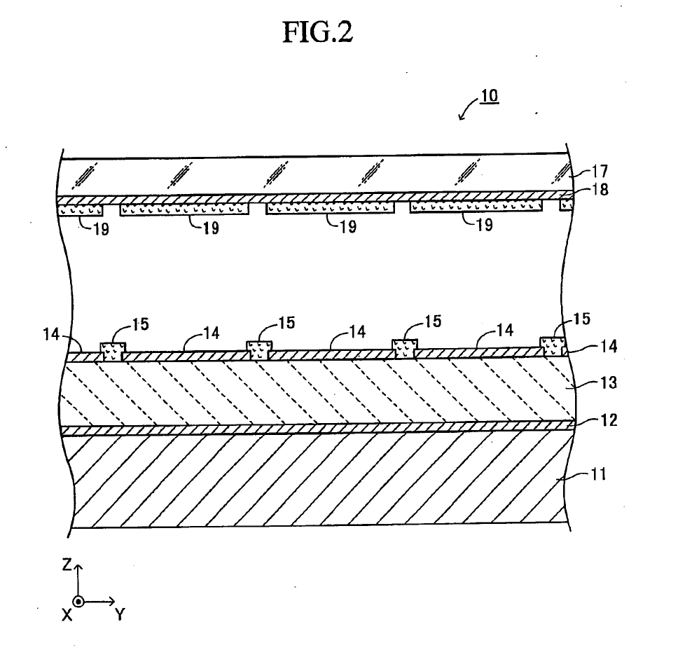

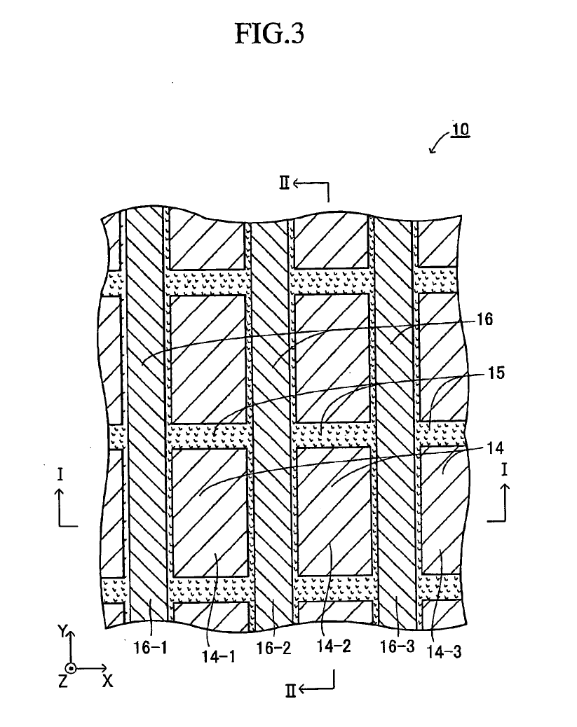

As shown in FIGS. 1 to 3, an electron emitting apparatus (an electron emitting device) 10 according to a first embodiment of the present invention includes a substrate 11, a plurality of lower electrodes (lower electrode layers) 12, an emitter section 13, a plurality of upper electrodes (upper electrode layers) 14, insulating layers 15, and a plurality of focusing electrodes (focusing electrode layers, a bundling electrode to bundle emitted electrons) 16. FIG. 1 is a cross-sectional view of the electron emitting apparatus 10 taken along line I-I in FIG. 3, which is a partial plan view of the electron emitting apparatus 10. FIG. 2 is a cross-sectional view of the electron emitting apparatus 10 taken along line II-II in FIG. 3.

The substrate 11 is a thin plate having an upper surface and a lower surface parallel to the plane (X-Y plane) defined by the X axis and the Y axis perpendicular to each other. The thickness direction of the substrate 11 is the Z-axis direction perpendicular to both the X and Y axes. The substrate 11 is mainly made of zirconium oxide, e.g., glass or ceramic.

Each of the lower electrodes 12 is a layer made of a conductive material, e.g., silver or platinum in this embodiment, and is disposed (formed) on the upper surface of the substrate 11. In a plan view, each lower electrode 12 has a shape of a strip, the longitudinal direction of which is the Y-axis direction. As shown in FIG. 1, the adjacent two lower electrodes 12 are apart from each other by a predetermined distance in the X-axis direction. Note that in FIG. 1, the lower electrodes 12 represented by reference numerals 12-1, 12-2, and 12-3 are respectively referred to as a first lower electrode, a second lower electrode, and a third lower electrode for the convenience sake.

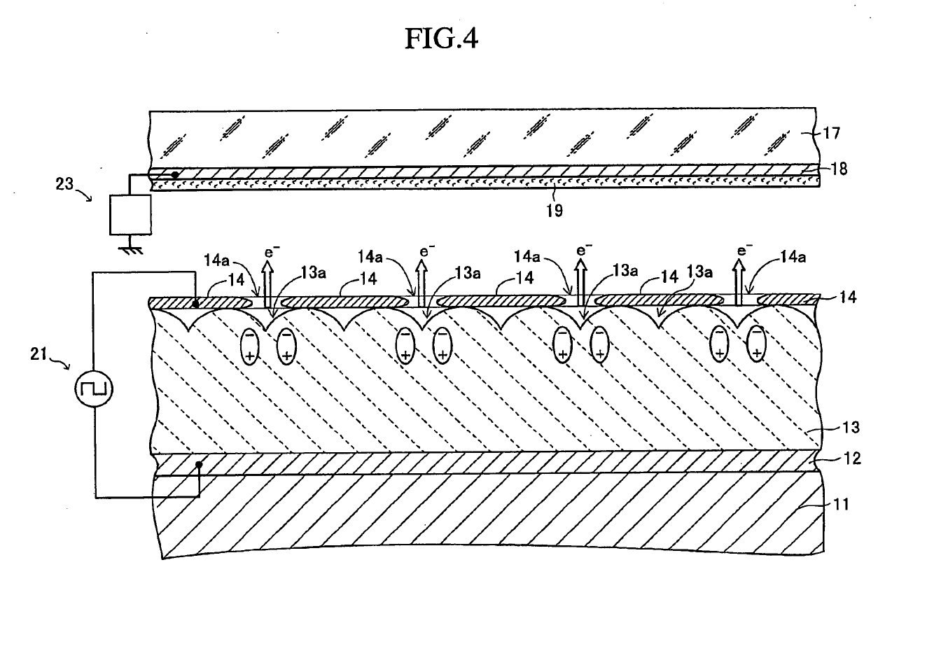

The emitter section 13 is made of a dielectric material having a high relative dielectric constant, or ferroelectric material, for example, a three-component material PMN-PT-PZ composed of lead magnesium niobate (PMN), lead titanate (PT), and lead zirconate (PZ). Materials for the emitter section 13 will be described in greater detail below. The emitter section 13 is disposed (formed) on the upper surfaces of the substrate 11 and lower electrodes 12. The emitter section 13 is a thin plate similar to the substrate 11. As shown in an enlarged view in FIG. 4, the upper surface of the emitter section 13 has irregularities (asperity) 13a formed by the grain boundaries of the dielectric material.

Each of the upper electrodes 14 is a layer made of a conductive material, i.e., platinum in this embodiment, and is disposed (formed) on the upper surface of the emitter section 13. As shown in a plan view of FIG. 3, each upper electrode 14 has a shape of a rectangle having a short side and a long side respectively lying in the X-axis direction and the Y-axis direction. The upper electrodes 14 are apart from one another and are arranged into a matrix. Each upper electrode 14 is opposed to the corresponding lower electrode 12. In a plan view, the upper electrode 14 is disposed at a position that overlaps the corresponding lower electrode 12.

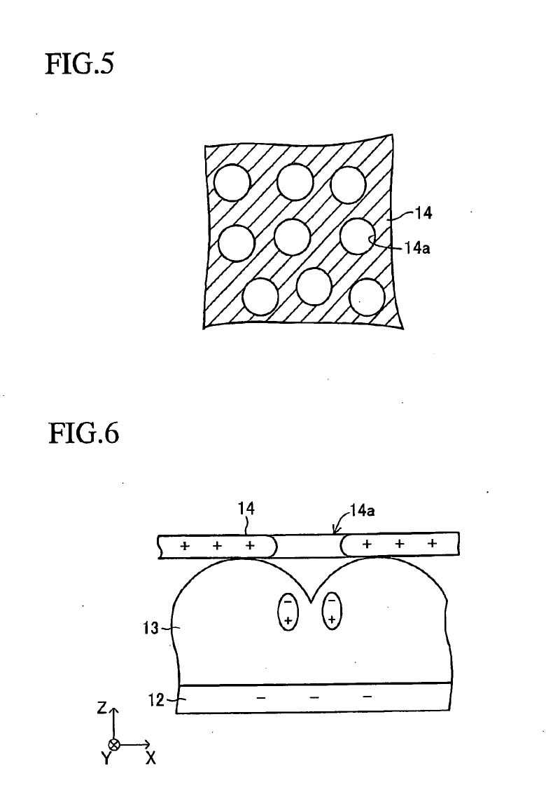

Furthermore, as shown in FIG. 4 and FIG. 5, which is a partial enlarged view of the upper electrode 14, each upper electrode 14 has a plurality of micro through holes 14a. Note that in FIGS. 1 and 3, the upper electrodes 14 represented by reference numerals 14-1, 14-2, and 14-3 are respectively referred to as a first upper electrode, a second upper electrode, and a third upper electrode for the convenience sake. The upper electrodes 14 aligned in the same row with respect to the X-axis direction (i.e., in the same row extending along the Y-axis direction) are connected to one another by a layer (not shown) made of a conductor and are maintained at the same electric potential.

The lower electrodes 12, the emitter section 13, and the upper electrodes 14 made of a platinum resinate paste are monolithically integrated by firing (baking). As a result of the firing, the upper electrode 14 shrinks and its thickness of the upper electrode 14 reduces, for example, from 10 μm to 0.1 μm. As a result, the micro through holes 14a are formed in the upper electrode 14.

The portion where an upper electrode 14 overlaps a corresponding lower electrode 12 in a plan view forms one (independent) element for emitting electrons. For example, the first lower electrode 12-1, the first upper electrode 14-1, and the portion of the emitter section 13 sandwiched between the first lower electrode 12-1 and the first upper electrode 14-1 form a first element. The second lower electrode 12-2, the second upper electrode 14-2, and the portion of the emitter section 13 sandwiched between the second lower electrode 12-2 and the second upper electrode 14-2 form a second element. The third lower electrode 12-3, the third upper electrode 14-3, and the portion of the emitter section 13 sandwiched between the third lower electrode 12-3 and the third upper electrode 14-3 form a third element. In this manner, the electron-emitting apparatus 10 includes a plurality of independent electron-emitting elements.

The insulating layers 15 are disposed (formed) on the upper surface of the emitter section 13 so as to fill the gaps between the upper electrodes 14. The thickness (the length in the Z-axis direction) of each insulating layer 15 is slightly larger than the thickness (the length in the Z-axis direction) of each upper electrode 14. As shown in FIGS. 1 and 2, the end portions of each insulating layer 15 in the X-axis direction and the Y-axis direction cover the end portions of the upper electrodes 14 in the X-axis and Y-axis directions, respectively.

Each of the focusing electrodes 16 is a layer made of a conductive material, i.e., silver In this embodiment, and are disposed (formed) on each of the insulating layers 15. As shown in a plan view of FIG. 3, each focusing electrode 16 has a shape of a strip whose longitudinal direction is the Y-axis direction. Each focusing electrode 16 is disposed (formed) between the adjacent upper electrodes 14 In the X-axis direction in the plan view. In detail, each focusing electrode 16 is disposed between the upper electrodes of the elements adjacent to each other in the X-axis direction and is slightly obliquely above the upper electrodes. All the focusing electrodes 16 are connected to one another by a layer (not shown) made of a conductor and maintained at the same potential.

In FIGS. 1 and 3, the focusing electrodes 16 represented by reference numerals 16-1, 16-2, and 16-3 are respectively referred to as a first focusing electrode, a second focusing electrode, and a third focusing electrode for the convenience sake. The second focusing electrode 16-2 lies between the first upper electrode 14-1 of the first element and the second upper electrode 14-2 of the second element and is located obliquely above the first and second upper electrodes 14-1 and 14-2. Similarly, the third focusing electrode 16-3 is between the second upper electrode 14-2 of the second element and the third upper electrode 14-3 of the third element and is located obliquely above the second and third upper electrodes 14-2 and 14-3.

The electron emitting apparatus 10 further Includes a transparent plate 17, a collector electrode (collector electrode layer) 18, and phosphors 19.

The transparent plate 17 is made of a transparent material (glass or acrylic resin in this embodiment), and is disposed above the upper electrodes 14 so that the transparent plate 17 is apart from the upper electrodes 14 in the positive direction of the Z axis by a predetermined distance. The upper and lower surfaces of the transparent plate 17 are parallel to the upper surfaces of the emitter section 13 and the upper electrodes 14, and lie in the X-Y plane.

The collector electrode 18 is made of a conductive material. In this embodiment, the collector electrode 18 is a transparent conductive film made of indium tin oxide (ITO) and is formed as a layer covering the entire lower surface of the transparent plate 17. In other words, the collector electrode 18 is disposed above the upper electrodes 14 and is opposed to the upper electrodes 14.

Each phosphor 19 emits red, green, or blue light by the collision of electrons. In a plan view, each phosphor 19 has substantially the same shape as that of the upper electrode 14 and overlaps the corresponding upper electrode 14. In FIG. 1, the phosphors 19 represented by reference numerals 19R, 19G, and 19B respectively emit red, green, and blue light. In this embodiment, the red phosphor 19R is disposed directly above the first upper electrode 14-1 (i.e., in the positive direction of the Z axis), the green phosphor 19G is disposed directly above the second upper electrode 14-2, and the blue phosphor 19B is disposed directly above the third upper electrode 14-3. The space surrounded by the emitter section 13, the upper electrodes 14, the insulating layers 15, the focusing electrodes 16, and the transparent plate 17 (the collector electrode 18) is maintained under substantial vacuum of preferably 10² to 10⁻⁶ Pa and more preferably 10⁻³ to 10⁻⁵ Pa.

In other words, the side walls (not shown) of the electron emitting apparatus 10, the transparent plate 17, and the collector electrode 18 serve as the members for defining a hermetically closed space (an enclosed space), and this hermetically closed space is maintained under substantial vacuum. The elements (at least the upper part of the emitter section 13 and the upper electrode 14 of each element) of the electron emitting apparatus 10 are disposed inside the hermetically closed space under substantial vacuum.

As shown in FIG. 1, the electron emitting apparatus 10 further includes a drive voltage applying circuit (drive voltage applying means or potential difference applying means) 21, a focusing electrode potential applying circuit (focusing electrode potential difference applying means) 22, and a collector voltage applying circuit (collector voltage applying means) 23.

The drive voltage applying circuit 21 has a power supply 21s for generating the drive voltage Vin (described in detail below). The power supply 21s is connected to the respective upper electrodes 14 and lower electrodes 12. That is, the drive voltage applying circuit 21 comprises the power supply 21s and a circuit that connects the power supply 21s to the respective elements. The drive voltage applying circuit 21 is also connected to a signal control circuit 100 and a power circuit 110 and applies the drive voltage Vin between the opposing pair of the upper electrode 14 and the lower electrode 12 (i.e., an element) based on a signal fed from the signal control circuit 100.

The focusing electrode potential applying circuit 22 is connected to the focusing electrode 16 and applies a predetermined constant negative voltage (potential) Vs to the focusing electrode 16.

The collector voltage applying circuit 23 applies a predetermined voltage (collector voltage) to the collector electrode 18 and includes a resistance 23a, a switching element 23b, a constant voltage source 23c for generating a predetermined voltage Vc, and a switch control circuit 23d. One end of the resistance 23a is connected to the collector electrode 18. The other end of the resistance 23a is connected to a fixed connection point of the switching element 23b. The switching element 23b is a semiconductor element, such as MOS-FET, and is connected to the switch control circuit 23d.

The switching element 23b has two switching points in addition to the above-described fixed connection point. In response to the control signal from the switch control circuit 23d, the switching element 23b selectively couples the fixed connection point to one of the two switching points. One of the two switching points is grounded, and the other is connected to the anode of the constant voltage source 23c. The cathode of the constant voltage source 23c is earthed. The switch control circuit 23d is connected to the signal control circuit 100, and controls the switching operation of the switching element 23b based on the signal received from the signal control circuit 100. Moreover, the switch control circuit 23d includes an element voltage measuring circuit and a detector circuit for detecting completion of electron emission, which will be described below.

Principle and Operation of Electron Emission

The principle of the electron emission of the electron emitting apparatus 10 having the above-described structure will now be explained. To simplify the explanation, in the description below, the drive voltage Vin generated by the power supply 21s is described as rectangular waves different from the drive voltage Vin of the first embodiment.

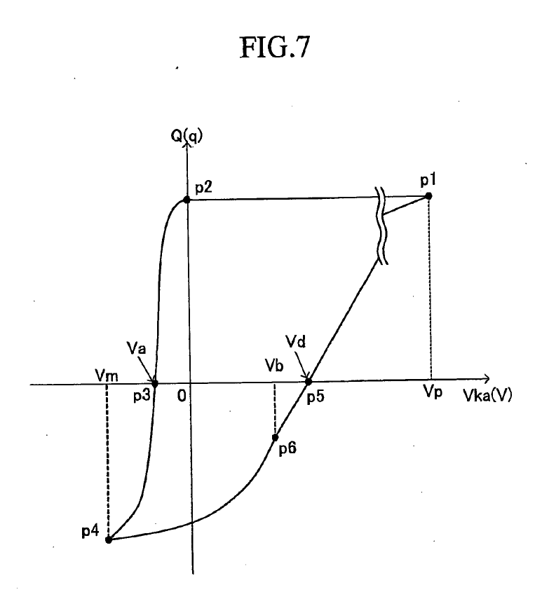

First, the state is described with reference to FIG. 6 in which the actual potential difference Vka (element voltage Vka) between the lower electrode 12 and the upper electrode 14 with reference to the lower electrode 12 is maintained at a predetermined positive voltage Vp and in which all the electrons in the emitter section 13 have been emitted without remaining in the emitter section 13. At this stage, the negative pole of the dipole in the emitter section 13 is oriented toward the upper surface of the emitter section 13, i.e., oriented in the positive direction of the Z axis toward the upper electrode 14. This state is observed at a point p1 on the graph in FIG. 7. The graph in FIG. 7 shows the voltage-polarization characteristic of the emitter section 13 and has the abscissa indicating the element voltage Vka and the ordinate indicating the charge Q near the upper electrode 14.

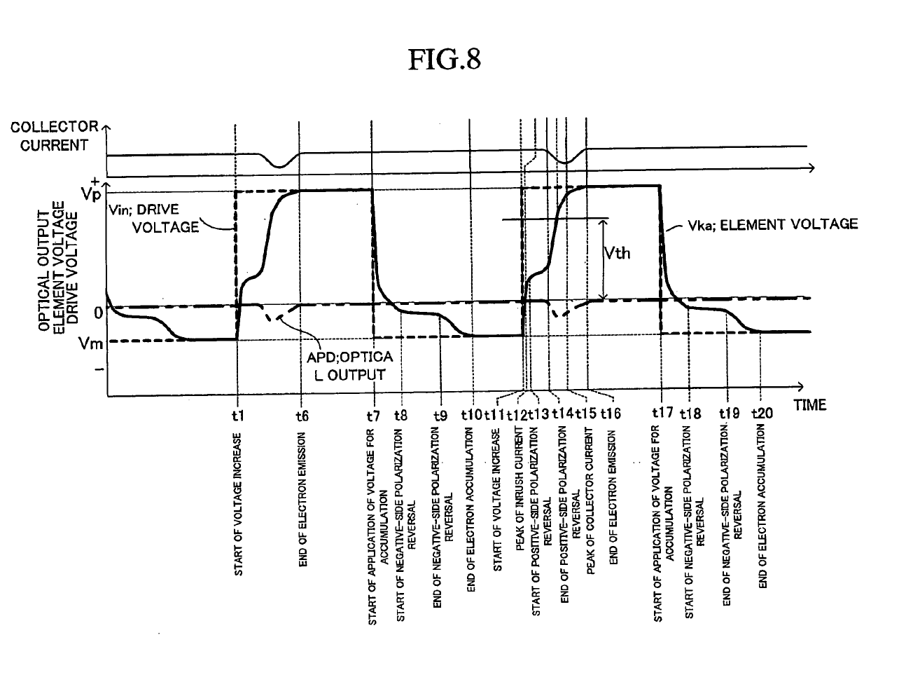

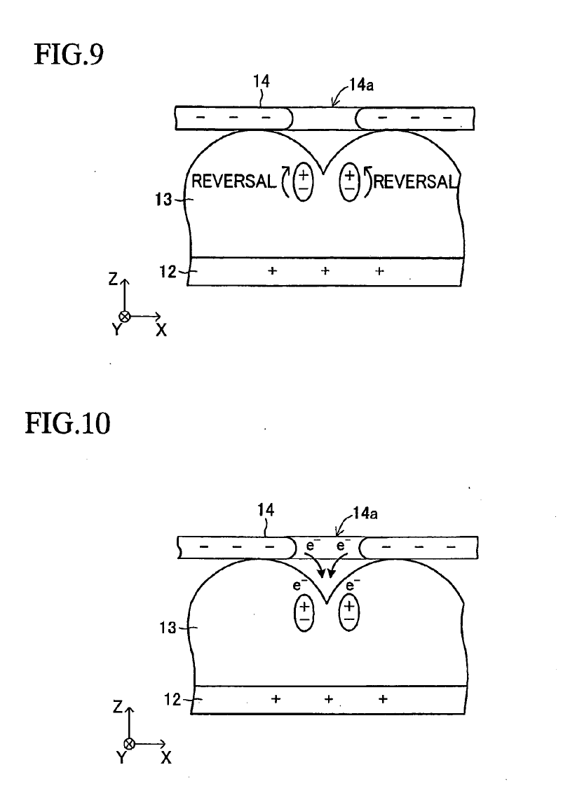

As observed at a time t7 in FIG. 8, the power supply 21s of the drive voltage applying circuit 21 decreases the drive voltage Vin toward a first voltage Vm, which is a negative predetermined voltage. By this operation, the element voltage Vka decreases toward a point p3 via a point p2 In FIG. 7. Once the element voltage Vka is decreased to a voltage near a negative coercive field voltage Va shown In FIG. 7, the reversal of the dipole in the emitter section 13 begins. In other words, as shown in FIG. 9, the polarization reversal (negative-side polarization reversal) begins. The polarization reversal increases the electric field in the contact sites (triple junctions) between the upper surface of the emitter section 13, the upper electrode 14, and the ambient medium (in this embodiment, vacuum) and/or the electric field at the end portions of the upper electrode 14 forming the micro through holes 14a. In other words, electrical field concentration occurs at these sites. As a result, as shown in FIG. 10, the electrons are started to be supplied toward the emitter section 13 from the upper electrodes 14.

The supplied electrons are accumulated mainly in the upper portion of the emitter section 13 near the region exposed through the micro through hole 14a and near the distal end portions of the upper electrode 14 that define the micro through hole 14a. This portion where the electrons are accumulated is hereinafter simply referred to as the region “near the micro through hole 14a”. Subsequently, at a time t9 in FIG. 8, the negative-side polarization reversal is completed, and the element voltage Vka rapidly changes toward the first voltage Vm (negative predetermined voltage), eventually reaching the first voltage Vm at a time t10. The electron accumulation is completed as a result, i.e., a saturation state of electron accumulation is reached. This state is observed at a point p4 in FIG. 7.

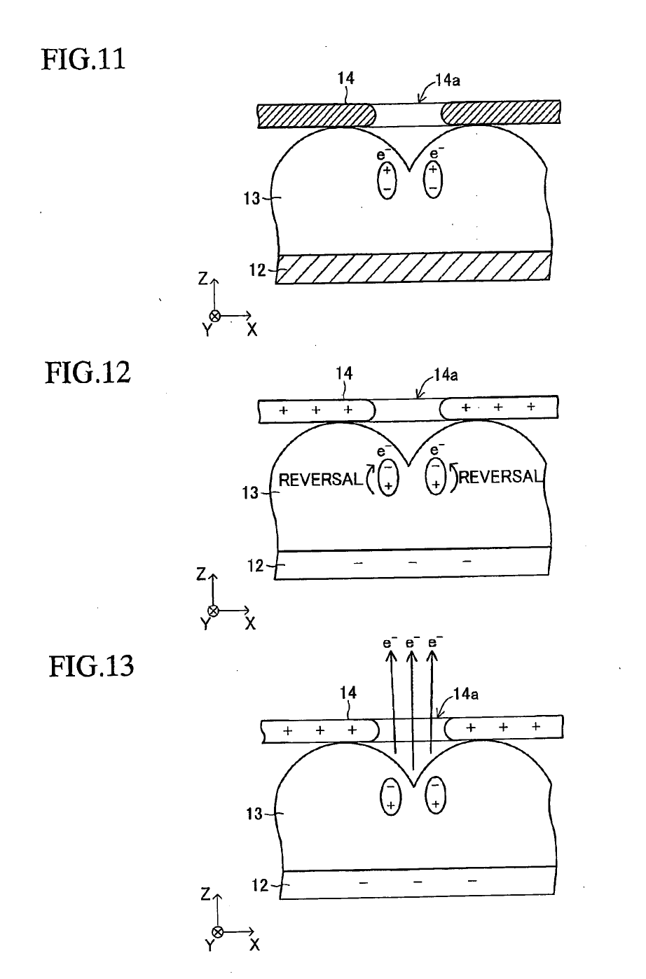

At a time t11 shown in FIG. 8, the drive voltage applying circuit 21 sets the drive voltage Vin at the a second voltage Vp, which is a positive predetermined voltage. By this operation, the element voltage Vka starts to increase. Here, until the element voltage Vka reaches a voltage Vb (point p6) slightly smaller than a positive coercive field voltage Vd corresponding to a point p5 in FIG. 7, the emitter section 13 remains charged, as shown In FIG. 11. Subsequently, at a time t13 shown in FIG. 8, the element voltage Vka reaches a voltage near the positive coercive field voltage Vd. Thus, the negative pole of the dipole starts to orient toward the upper surface of the emitter section 13. In other words, as shown in FIG. 12, polarization reversal occurs again, i.e., the positive-side polarization reversal begins. This state is observed near the point p5 show in FIG. 7.

Subsequently, at a time near a time t14 in FIG. 8 at which the positive-side polarization reversal is completed, the number of the dipoles having negative poles oriented toward the upper surface of the emitter section 13 increases. As a result, as shown in FIG. 13, the electrons accumulated near the micro through holes 14a are started to be emitted in the upward direction (the positive direction of the Z axis) through the micro through holes 14a by Coulomb repulsion.

At a time t14 in FIG. 8, the positive-side polarization reversal is completed. The element voltage Vka starts to increase rapidly, and electrons are actively emitted. At a time t16, electron emission is completed, and the element voltage Vka reaches the positive predetermined voltage Vp. As a result, the state of the emitter section 13 is returned to its initial state shown in FIG. 6 observed at the point p1 in FIG. 7. This summarizes the principle of a series of operation including electron accumulation (light OFF state) and electron emission (light ON or emission state).

Note that, if the electron-emitting apparatus includes two or more electron-emitting elements, the drive voltage applying circuit 21 sets the drive voltage Vin of only the upper electrodes 14 from which electron emission is required at the predetermined negative voltage Vm to accumulate electrons, and maintains the drive voltage Vin of upper electrodes 14 from which no electron emission is required at zero. Subsequently, the drive voltage applying circuit 21 simultaneously sets the drive voltage of all of the-upper electrodes 14 at the predetermined positive value Vp. According to this arrangement, electrons are emitted from the upper electrodes 14 (the micro through holes 14a) of only the elements in which electrons have been accumulated in the emitter section 13. Thus, no polarization reversal occurs in the portions of emitter section 13 near the upper electrodes 14 from which no electron emission is required.

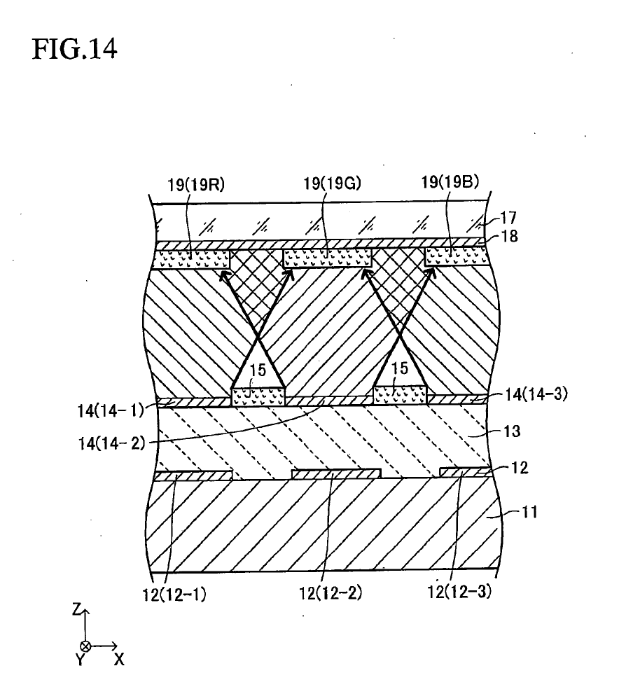

When electrons are emitted through the micro through holes 14a of the upper electrodes 14, the electrons travel in the positive direction of the Z axis by spreading into the shape of a cone, as shown in FIG. 14. Thus, in an apparatus of the related art, electrons emitted from one upper electrode 14, e.g., the second upper electrode 14-2, reach not only the phosphor 19, e.g., the green phosphor 19G, directly above that upper electrode 14 but also the phosphors 19, e.g., the red phosphor 19R and the blue phosphor 19B, adjacent to this phosphor 19. This decreases color purity and sharpness of Images.

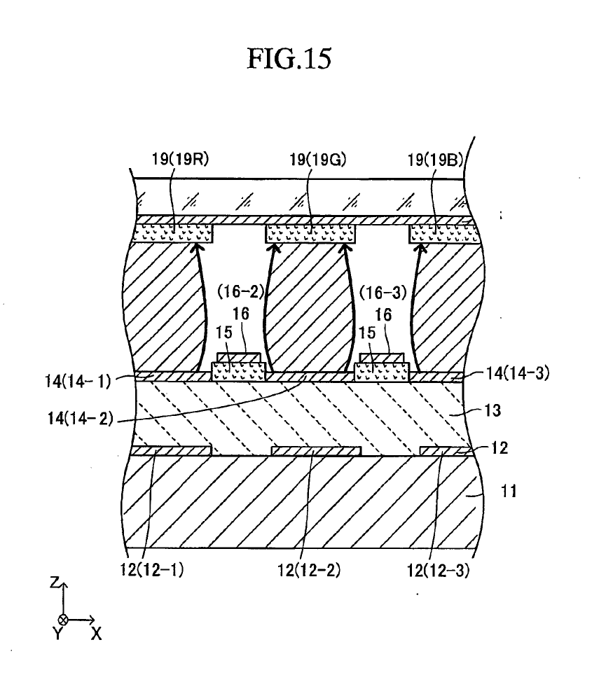

In contrast, the electron emitting apparatus 10 of this embodiment has focusing electrodes 16 to which a negative potential is applied. Each focusing electrode 16 is interposed between the adjacent upper electrodes 14 (i.e., between the upper electrodes of the adjacent elements) and is disposed at a position slightly above the upper electrodes 14. Thus, as shown in FIG. 15, the electrons emitted from the micro through holes 14a travel substantially directly upward without spreading owing to the electric field generated by the focusing electrode 16.

As a result, the electrons emitted from the first upper electrode 14-1 reach only the red phosphor 19R, the electrons emitted from the second upper electrode 14-2 reach only the green phosphor 19G, and the electrons emitted from the third upper electrode 14-3 reach only the blue phosphor 19B. Thus, the color purity of the display does not decrease, and sharper images can be obtained.

Unnecessary Electron Emission and Assumption of Reason for Such Emission

In the electron emitting apparatus 10 that operates as described above, it is understood from the collector current (the amount of electrons reaching the collector electrode per unit time) shown in FIG. 8, that electron emission starts near the time t14 and reaches the maximum emission per unit time at the time t15. The electron emission is completed at the time t16. That is, during this period, proper (regular) emission is observed. However, experiments conducted by the inventors have reported that unexpected emission (unnecessary electron emission) occurs as described below.

(1) Normal Emission

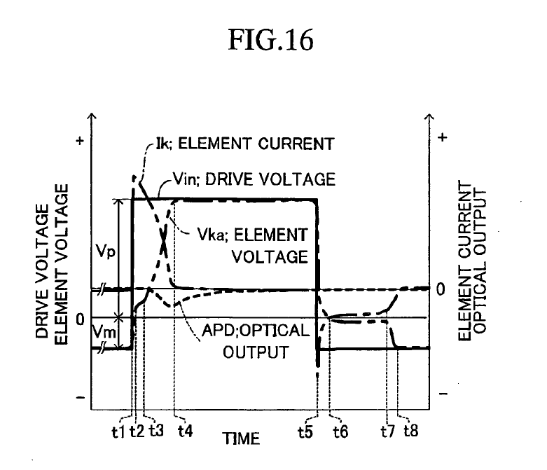

Firstly, the changes in drive voltage Vin, element voltage Vka, element current Ik, and optical output APD versus drive voltage Vin that varies in the form of rectangular waves during normal electron emission (light emission) will be described with reference to FIG. 16. Here, the element current Ik is current flowing in the portion of the emitter section 13 sandwiched between the lower electrode 12 and the upper electrode 14. The optical output APD is a value obtained by converting the emitted light with an avalanche photodiode. In the graph, the value is indicated as a negative value.

As shown in FIG. 16, when the drive voltage Vin is risen steeply at the time t1 so that it is changed from the first voltage (negative predetermined voltage) Vm to the second voltage (positive predetermined voltage) Vp, a large inrush current flows in the emitter section 13. Accordingly, the element current Ik reaches its peak Immediately after the time t1 and subsequently reaches zero relatively quickly. On the other hand, between the time t2 to t3 immediately after the time t1, the positive-side polarization reversal occurs. Thus, the element voltage Vka rapidly increases between the time t1 to the time t2 and then moderately increases between the time t2 to the time t3. After the positive-side polarization reversal ends (i.e., the positive coercive field voltage is exceeded) at the time t3, the element voltage Vka increases until the time t4 and becomes equal to the second voltage Vp of the drive voltage Vin thereafter. It is understood from the optical output APD that the electron emission (light emission) starts near the time t3, reaches the maximum immediately before the time t4, and then stops.

When the drive voltage Vin is risen steeply so that it is changed from the second voltage (positive predetermined voltage) Vp to the first voltage (negative predetermined voltage) Vm at the time t5, a large negative inrush current flows in the emitter section 13. Thus, the element current Ik reaches its peak immediately after the time t5. Between the time t6 and the time t7 immediately after the time t5, the negative-polarization reversal occurs. Thus, after a rapid decrease between the time t5 and the time t6, the element voltage Vka stays substantially constant until the time t7. After the negative-side polarization reversal ends (i.e., the negative coercive field voltage is exceeded) at the time t7, the element voltage Vka rapidly decreases until the time t8. At the time t8 and thereafter, the element voltage Vka becomes equal to the first voltage Vm of the drive voltage Vin. Meanwhile, the element current Ik rapidly increases toward zero between the time t5 and the time t6, then stays substantially constant until the time t7, and again rapidly increases toward zero between the time t7 and the time t8. As can be understood from FIG. 16, no electron is emitted between the time t5 and the time t8.

(2) Abnormal Emission (Electron Emission at Inappropriate Timing and Excessive Electron Emission)

Next, the timing of unnecessary electron emission (including excessive electron emission) caused by the drive voltage Vin varying in the form of rectangular waves is explained.

Unnecessary electron emission mainly occurs at the following four time points:

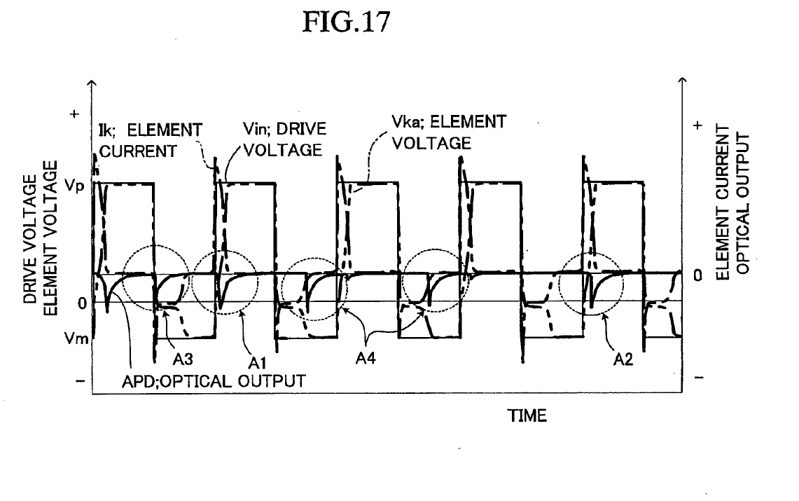

(A) Referring to a region A1 in FIG. 17, unnecessary electron emission occurs immediately after the drive voltage Vin is changed from the first voltage Vm which is a negative predetermined voltage (or from third voltage Vn equal to an intermediate voltage applied for non-selection of element described below) to the second voltage Vp which is a positive predetermined voltage. In other words, unnecessary electron emission occurs immediately after the time t1 and t11 in FIG. 8 and the time t1 in FIG. 16, which is the time point at which the drive voltage VIn is risen to initiate electron emission. This unnecessary electron emission is presumably due to a large inrush current (excessively large element current Ik) flowing between the upper electrode 14 and the lower electrode 12, i.e., in the emitter section 13.

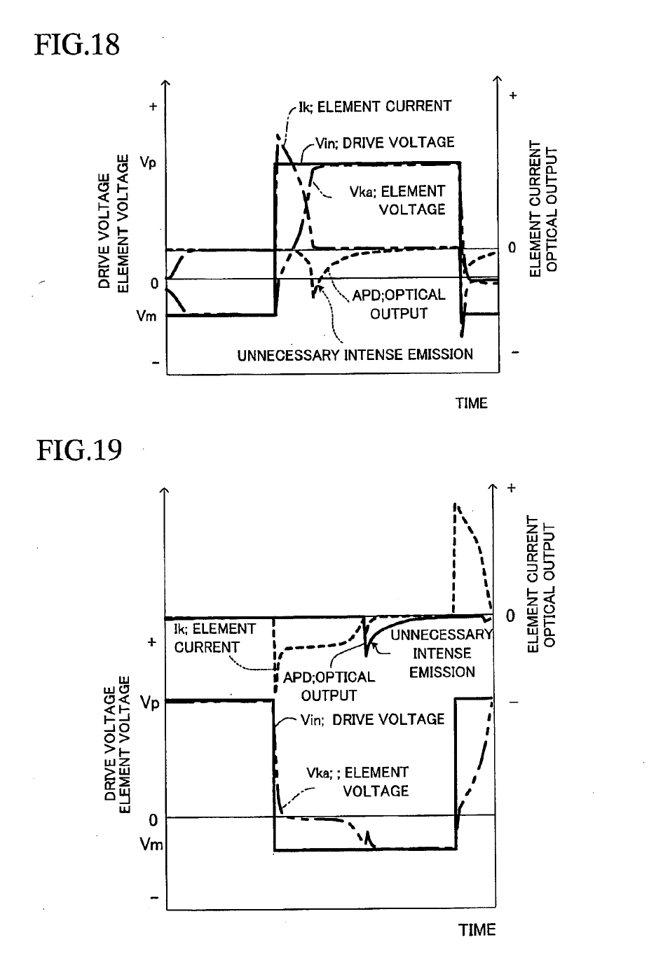

(B) Referring to a region A2 in FIG. 17 and FIG. 18, unnecessary electron emission occurs immediately after the completion of the positive-polarization reversal caused by setting the drive voltage Vin to the second voltage Vp. In other words, unnecessary electron emission occurs immediately after time t14 in FIG. 8 and time t3 in FIG. 16. This unnecessary electron emission is presumably due to a rapid change in element voltage Vka immediately after the completion of the positive-side polarization reversal in the emitter section 13, i.e., immediately after the positive coercive field voltage is exceeded. In other words, this is presumably due to an excessively large rate of change in element voltage Vka over time (dVka/dt).

(C) Referring now to a region A3 in FIG. 17, unnecessary electron emission occurs immediately after the drive voltage Vin is changed from the second voltage Vp which is the positive predetermined voltage to the first voltage Vm which is the negative predetermined voltage. That is, this unnecessary electron emission occurs immediately after the drive voltage Vin is rapidly decreased to initiate electron emission (i.e., immediately after the time t7 and the time t17 in FIG. 8 and the time t5 in FIG. 16). This unnecessary electron emission is presumably due to a large inrush current (excessively large element current Ik) caused by the rapid change in the drive voltage Vin.

(D) Referring to a region A4 in FIG. 17 and FIG. 19, unnecessary electron emission occurs immediately after the completion of the negative-side polarization reversal caused by setting the drive voltage Vin to the first voltage Vm which is the negative predetermined voltage, i.e., immediately after the time t9 and the time t19 in FIG. 8 and the time t7 in FIG. 16. This unnecessary electron emission is presumably due to a rapid change in element voltage Vka after completion of the negative-side polarization reversal in the emitter section 13, i.e., due to an excessively large rate of change in element voltage Vka over time (dVka/dt).

(3) Relationship Between Rate of Change in Voltage During Period of Increasing Drive Voltage Vin, Element Voltage Vka, and Element Current Ik

Based on the findings above, the inventors have studied the characteristics of the element voltage Vka and the element current Ik when the drive voltage Vin for electron emission is changed from rectangular waves to gradually increasing voltage and when the rate of change (the rate of change in voltage with respect to time elasp=dVin/dt) is set at various values.

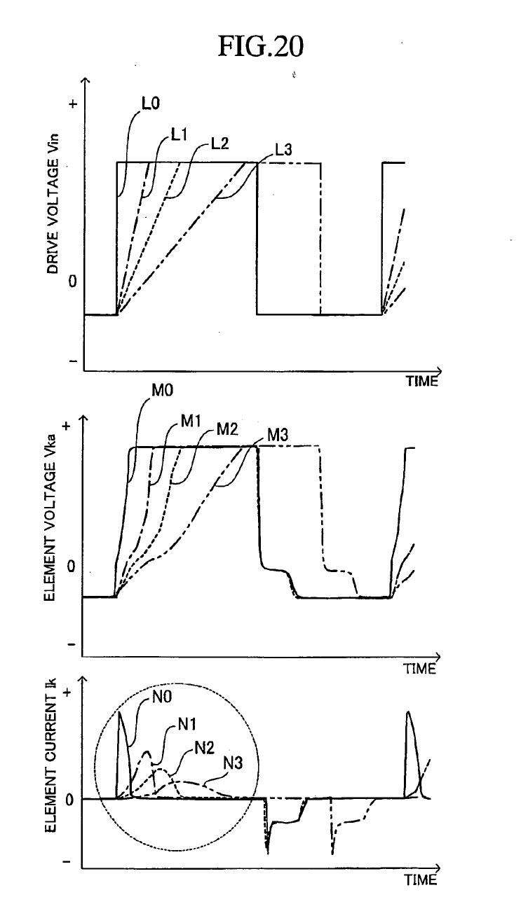

FIG. 20 includes time charts showing the results of an experiment. In FIG. 20, a line L0 shows a conventional drive voltage Vin in rectangular waves, a line M0 and a line N0 respectively show the element voltage Vka and the element current Ik in response to the drive voltage Vin indicated by the line L0. A line L1 shows a drive voltage Vin gradually increasing at a predetermined rate α1 of change, i.e., an inclination or dVin/dt. A line M1 and a line N1 respectively represent the element voltage Vka and the element current Ik in response to the drive voltage Vin indicated by the line L1.

Similarly, a line L2 shows a drive voltage Vin gradually increasing at a predetermined rate α2 of change, and a line M2 and a line N2 respectively show the element voltage Vka and the element current Ik in response to the drive voltage Vin indicated by the line L2. A line L3 shows a drive voltage Vin gradually increasing at a predetermined rate α3 of change, and a line M3 and a line N3 respectively show the element voltage Vka and the element current Ik in response to the drive voltage Vin indicated by the line L3. Here, α1>α2>α3>0.

As shown in FIG. 20, the peak (maximum value) of the element current Ik is smaller as the rate of change in drive voltage Vin is smaller during the period of increasing the drive voltage Vin to conduct electron emission (refer to the portion of the element current Ik circled by a dotted line). In particular, it can be understood from the lines L3, M3, and N3 that, by controlling the rate of change in drive voltage Vin so that the element voltage Vka changes by tracking (i.e., Vka follows closely to) the changes in drive voltage Vin, the peak of the element current Ik can be effectively reduced.

(4) Relationship Between Rate of Change in Drive Voltage Vin, Element Voltage Vka, and Element Current Ik During Period of Decreasing Drive Voltage Vin

The inventor has also studied the characteristics of the element voltage Vka and the element current Ik when the drive voltage Vin for electron emission is gradually reduced during the period of accumulating the electrons in the emitter section. 13, for various rate of change in drive voltage Vin over time.

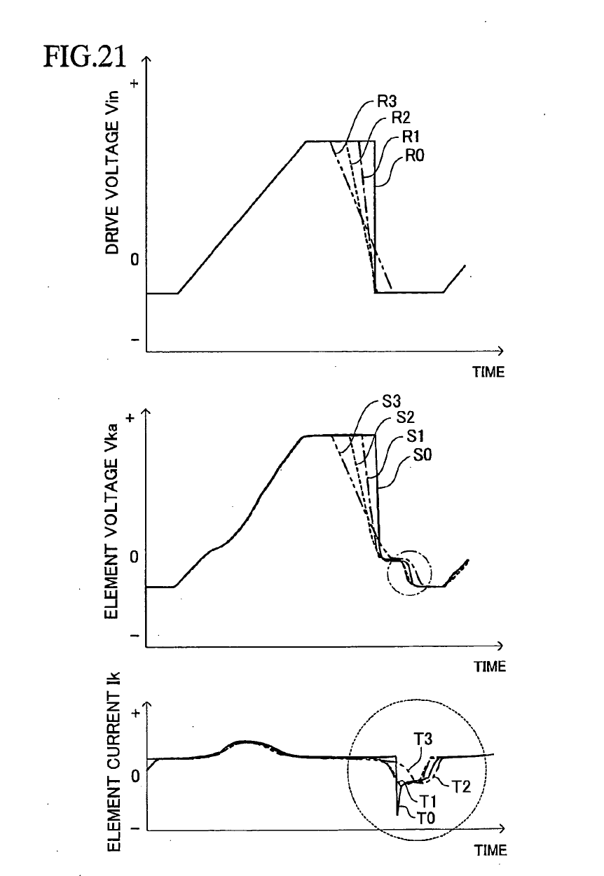

FIG. 21 includes time charts showing the results of an experiment. In FIG. 21, a line R0 shows a conventional drive voltage Vin that has a rectangular falling edge, and a line S0 and a line T0 respectively show the element voltage Vka and the element current Ik in response to the drive voltage Vin shown by the line R0. A line R1 shows a drive voltage Vin gradually decreasing at a predetermined rate β1 of change, i.e., a predetermined inclination or |dVin/dt |, and a line S1 and a line T1 respectively show the element voltage Vka and the element current Ik In response to the element voltage Vka shown by the line R1.

Similarly, a line R2 shows a drive voltage Vin gradually decreasing at a predetermined rate β2 of change (|dVin/dt|), and a line S2 and a line T2 respectively indicate the element voltage Vka and the element current Ik in response to the drive voltage Vin shown by the line R2. A line R3 shows a drive voltage Vin gradually decreasing at a predetermined rate β3 of change (|dVin/dt|), and a line S3 and a line T3 respectively indicate the element voltage Vka and the element current Ik in response to the drive voltage Vin indicated by the line R3. Here, β1>β2>β3>0.

As shown in FIG. 21, the peak (maximum value) of the element current Ik is smaller as the rate of change in drive voltage Vin is smaller during the period of decreasing the drive voltage Vin to conduct electron accumulation (refer to the portion of the element current Ik circled by a dotted line). Moreover, the rate of change in element voltage Vka after completion of the negative-side polarization reversal decreases slightly as the rate of change in drive voltage Vin is decreased (refer to the portion of the element voltage Vka circled by a alternate long and short dash line).

Control of Drive Voltage

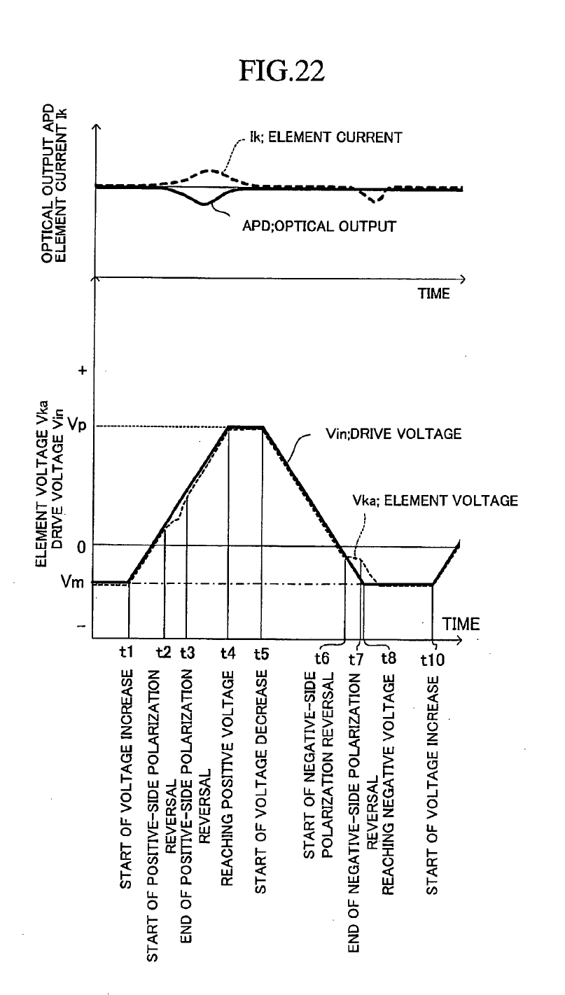

Based on the results of the experiments described above, the drive voltage applying circuit 21 according to the first embodiment generates a drive voltage Vin having a characteristic shown in FIG. 22. Specifically, the power supply 21s of the drive voltage applying circuit 21 starts to increase the drive voltage Vin from the first voltage Vm (which is the negative predetermined voltage) at a particular time (time t1 shown in FIG. 22). The power supply 21s gradually increases the drive voltage Vin at a predetermined rate α(=dVin/dt>0) so that the drive voltage Vin reaches the second voltage Vp (which is the predetermined positive voltage) at a time t4 after the start of the positive-side polarization reversal (time t2) and the completion of the positive-side polarization reversal (time t3 at which the positive coercive field voltage is exceeded).

With the drive voltage Vin above, the inrush current (the peak value of the element current Ik) that occurs during the electron emission caused by the increased drive voltage Vin can be reduced, and the rapid change in element voltage Vka that would occur after the completion of the positive-side polarization reversal can be avoided. As a result, unnecessary electron emission that occurs during the period of increasing the drive voltage Vin can be avoided.

At a particular time (t5) after the completion of the electron emission (time t4), the power supply 21s of the drive voltage applying circuit 21 starts to decrease the drive voltage Vin from the second voltage Vp at a predetermined rate β of change so that the drive voltage Vin reaches the first voltage Vm after the start of the negative-side polarization reversal (time t6) and completion of the negative-side polarization reversal (time t7 at which the negative-side coercive field voltage is exceeded).

With the drive voltage Vin above, the inrush current (the peak value of the element current Ik) that occurs during the electron accumulation caused by decreasing drive voltage Vin can be reduced, and the rapid change in element voltage Vka after the negative-side polarization reversal can be avoided. As a result, unnecessary electron emission during the period of decreasing the drive voltage Vin can be avoided.

Control of Collector Electrode

The collector voltage applying circuit 23 applies a second collector voltage V2 to the collector electrode 18 so that the collector voltage is changed from the first predetermined voltage to a second predetermined voltage smaller than the first predetermined voltage at a particular time point within the period from immediately after the time t4 to the time t5 in FIG. 22. Here, “immediately after the time t4” means the time point at which the electron emission through the micro through holes 14a caused by changing the drive voltage Vin toward the second voltage Vp (predetermined positive voltage) is substantially completed. The time t5 is the time at which drive voltage Vin starts to decrease from the second voltage Vp which is the predetermined positive voltage. That is, the collector voltage applying circuit 23 switches the connecting point to which the fixed connection point of the switching element 23b is connected from the switching point connected to the constant voltage source 23c to the earthed switching point.

Note that the switching element 23b may be configured such that the earthed switching point is replaced by a floating point coupled to nowhere. In this case, the collector electrode 18 is caused to enter a floating state, by a switching operation in which the point coupled to the fixed connection point is switched from the switching point coupled to the constant voltage source 23c to the switching point in the floating state. Here, both the operation in which the second collector voltage V2 is applied to the collector electrode 18 by earthing (grounding) the collector electrode 18 and the operation in which the collector electrode 18 is put under a floating state are each referred to as “turning the collector electrode off” hereinafter.

When the collector electrode 18 is turned off, the collector electrode 18 does not generate an electric field that attracts the emitted electrons or the collector electrode 18 decreases the Intensity of such electric field. As a result, unnecessary electron emission (and unnecessary light emission) can be avoided.

Subsequently, the collector voltage applying circuit 23 switches the connecting point to which the fixed connection point of the switching element 23b Is connected from the earthed switching point to the switching point connected to the constant voltage source 23c at a particular time within a period from the time t8 in FIG. 22 to the time before the completion of the next electron emission. Here, the time t8 is a time at which electron accumulation by changing the drive voltage Vin to the first voltage Vm is substantially completed. In other words, the collector voltage applying circuit 23 resumes application of the first collector voltage V1 (Vc) to the collector electrode 18 at this particular time. This time point is also referred to as the “collector electrode ON time” for the convenience sake.

By this operation, the emitted electrons are accelerated (i.e., given high energy) by the electric field generated by the collector electrode 18 and travel in the upward direction from the upper electrode 14. Thus, the phosphors 19 are irradiated with electrons having high energy, and therefore, high luminance is achieved. In other words, since the collector electrode 18 to which the first collector voltage V1 is applied attracts the emitted electrons, a desired amount of electrons can reach near the collector electrode 18.

By controlling the collector electrode 18 as such, at least during the period from the start of the voltage decrease to the completion of the electron accumulation, either the collector voltage is maintained at the second predetermined voltage (in this embodiment, 0 V, which is the ground potential) or the collector electrode is maintained in the floating state.

As a result, unnecessary electron emission presumably caused by a large inrush current flowing in the emitter section 13 during the electron accumulation can be securely avoided. Moreover, unnecessary electron emission presumably resulting from a high rate of change in element voltage Vka occurring Immediately after completion of the negative-side polarization reversal can be securely avoided.

The collector electrode ON time may be set as follows:

(a) The collector electrode ON time may be set at a time point (t10 in FIG. 22) at which the drive voltage Vin starts to increase from the first voltage Vm toward the second voltage Vp.

According to the collector electrode ON time in the case (a) above, unnecessary electron emission during the electron accumulation (from t5 to t10 in FIG. 22) can be avoided. Furthermore, since the first collector voltage is applied to the collector electrode 18 over the entire period in which the drive voltage Vin is increasing for electron emission, the electron normally emitted can be led to the collector electrode 18. In addition, since the time point at which the drive voltage Vin starts to increase is coincident with the time point at which the first collector voltage is applied to the collector electrode, the circuit configuration for this operation can be simplified.

(b) The collector electrode ON time may be set at a particular time between the time point at which the inrush current in the emitter section 13 reaches the maximum by the increase of the drive voltage Vin toward the second voltage Vp and the time point at which the positive-side polarization reversal is completed.

According to the collector electrode ON time in the case (b) above, unnecessary electron emission during the electron accumulation (from t5 to t10 in FIG. 22) and unnecessary electron emission resulting from a large inrush current at the time of increasing the drive voltage Vin can be avoided. In addition, after the completion of the positive-side polarization reversal, the first collector voltage is applied to the collector electrode. Thus, the electrons normally emitted after the positive-side polarization reversal can be led toward the collector electrode.

(c) The collector electrode ON time may be set at a particular time between the completion of the positive-side polarization reversal and the substantial completion of the electron emission.

According to the collector electrode ON time in the case (c) above, unnecessary electron emission during the electron accumulation (from t5 to t10 in FIG. 22) can be avoided. Moreover, It is possible to avoid unnecessary electron emission due to an inrush current and the like before the completion of the positive-side polarization reversal while the drive voltage Vin is increasing. Besides, at the time point before the completion of the electron emission, the first collector voltage is applied to the collector electrode. Thus, the electrons normally (properly) emitted can be led to the collector electrode. Furthermore, since the first collector voltage is applied to the collector electrode substantially only during the designed electron emission period, excessive electron emission can be effectively suppressed.

(d) The collector electrode ON time may be set at a particular time between the completion of the positive-side polarization reversal and the time point at which the amount of the electrons emitted from the emitter section and reaching the collector electrode (the current flowing in the collector electrode) reaches per unit time the maximum.

According to the collector electrode ON time in the case (d) above, unnecessary electron emission during the electron accumulation (t5 to t10 in FIG. 22) can be avoided. Moreover, It is possible to avoid unnecessary electron emission due to an inrush current and the like before the completion of the positive-side polarization reversal while the drive voltage Vin is increasing. Besides, after the current flowing in the collector electrode reaches the maximum, the first collector voltage is applied to the collector electrode. Thus, the electrons normally (properly) emitted can be securely led to the collector electrode. In other words, it becomes possible to ensure the required amount of electron emission while avoiding excessive electron emission.

(e) The collector electrode ON time may be set to the time point at which the actual element voltage Vka reaches a predetermined threshold voltage Vth while the drive voltage Vin is being increased. In this case, the predetermined threshold voltage Vth is preferably selected such that the collector electrode ON time falls in between the time point of the completion of the positive-side polarization reversal and the time point at which the current flowing the collector electrode reaches the maximum.

According to the collector electrode ON time in the case (e) above, unnecessary electron emission during the electron accumulation (t5 to t10 in FIG. 22) can be avoided. Moreover, unnecessary electron emission due to an inrush current and the like at the start of the increase of the drive voltage Vin can be avoided. In addition, since the element voltage Vka varies depending on the images (the amount of electrons required to be emitted) to be displayed, the collector electrode can be turned on at an appropriate timing despite the manner in which the element voltage Vka changes. Here, said “appropriate timing” is one that can lead as many electrons normally emitted as possible to the collector electrode while suppressing unnecessary electron emission.

Specific Examples of Drive Voltage Applying Circuit, Focusing Electrode Potential Applying Circuit, and Collector Voltage Applying Circuit

The specific examples and operation of the drive voltage applying circuit 21, the focusing electrode potential applying circuit 22, and the collector voltage applying circuit 23 will now be explained.

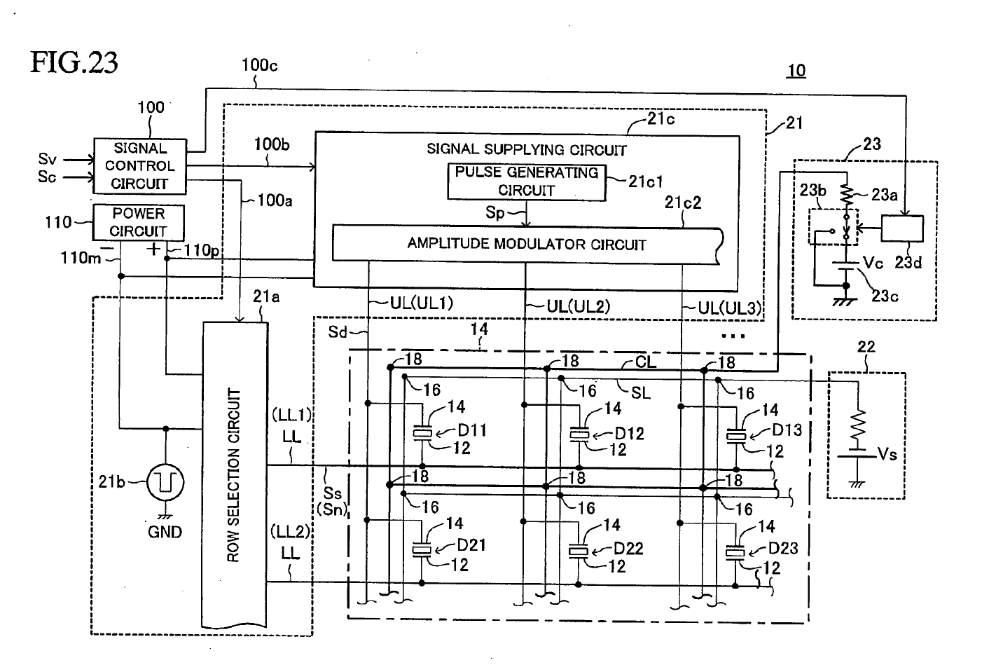

As shown in FIG. 23, the drive voltage applying circuit 21 includes a row selection circuit 21a, a pulse generator 21b, and a signal supplying circuit 21c. In FIG. 23, the components labeled D11, D12, . . . D22, and D23 each represent one element, i.e., an electron-emitting element (one element constituted from the portion where upper electrode 14 is superimposed on the lower electrode 12 with the emitter section 13 therebetween). In this embodiment, the electron emitting apparatus 10 has a number n of elements in the row direction and a number m of elements In the column direction.

The row selection circuit 21a is connected to a control signal line 100a of the signal control circuit 100 and a positive electrode line 110p and a negative electrode line 110m of the power circuit 110. The row selection circuit 21a is also connected to a plurality of row selection lines LL. Each row selection line LL is connected to the lower electrodes 12 of a series of elements in the same row. For example, a row selection line LL1 is connected to the lower electrodes 12 of elements D11, D12, D13, . . . and D1m in the first row, and a row selection line LL2 is connected to the lower electrodes 12 of elements D21, D22, D23, . . . and D2m in the second row.

During the charge accumulation period Td in which electrons are accumulated in the emitter section 13 of each element, the row selection circuit 21a outputs a selection signal Ss (a 50-V voltage signal in this embodiment) to one of the row selection lines LL for a predetermined period (row selection period) Ts and outputs non-selection signals Sn (a 0-V voltage signal in this embodiment) to the rest of the row selection lines LL in response to the control signal from the signal control circuit 100. The row selection line LL to which the selection signal Ss is output from the row selection circuit 21a is sequentially changed every period Ts.

The pulse generator 21b generates a reference voltage (0 V in this embodiment) during a charge accumulation period Td and a predetermined fixed voltage (−400 V in this embodiment) during an emission period (electron emitting period or light ON period) Th. The pulse generator 21b is coupled between the negative electrode line 110m of the power circuit 110 and the ground (GND).

The signal supplying circuit 21c is connected to the a control signal line 100b of the signal control circuit 100 and the positive electrode line 110p and the negative electrode line 110m of the power circuit 110. The signal supplying circuit 21c has a pulse generating circuit 21c1 and an amplitude modulator circuit 21c2 inside.

The pulse generating circuit 21c1 outputs a pulse signal Sp having a predetermined amplitude (50 V in this embodiment) at a predetermined pulse period during the charge accumulation period Td, and outputs a reference voltage (0 V in this embodiment) during the emission period Th.

The amplitude modulator circuit 21c2 is connected to the pulse generating circuit 21c1 so as to receive the pulse signal Sp from the pulse generating circuit 21c1. Further, the amplitude modulator circuit 21c2 is connected to a plurality of pixel signal lines UL. Each pixel signal line UL is connected the upper electrodes 14 of a series of elements in the same column. For example, a pixel signal line UL1 is connected to the upper electrodes 14 of the elements D11, D21, . . . and Dn1 of the first column, a pixel signal line UL2 is connected to the upper electrodes 14 of the elements D12, D22, . . . and Dn2 of the second column, and a pixel signal line UL3 is connected to the upper electrodes 14 of the elements D13, D23, . . . and Dn3 of the third column.

During the charge accumulation period Td, the amplitude modulator circuit 21c2 modulates the amplitude of the pulse signal Sp according to the luminance levels of the pixels in the selected row, and outputs the modulated signal (a voltage signal of 0 V, 30 V, or 50 V in this embodiment), which serves as a pixel signal Sd, to the pixel signal lines UL (UL1, UL2, . . . and ULm). During the emission period Th, the amplitude modulator circuit 21c2 outputs, without any modulation, the reference voltage (0 V) generated by the pulse generating circuit 21c1.

The signal control circuit 100 receives a video signal Sv and a sync signal Sc and outputs a signal for controlling the row selection circuit 21a to the signal line 100a, a signal for controlling the signal supplying circuit 21c to the signal line 100b, and a signal for controlling the collector voltage applying circuit 23 to a signal line 100c based on these received signals.

The power circuit 110 outputs voltage signals to the positive electrode line 110p and the negative electrode line 110m so that the potential of the positive electrode line 110p is higher than the potential of the negative electrode line 110m by a predetermined voltage (50 V in this embodiment).

The focusing electrode potential applying circuit 22 is coupled to a connecting line SL that connects all of the focusing electrodes 16. The focusing electrode potential applying circuit 22 applies to the connecting line SL a potential Vs (e.g., −50 V) with respect to the ground.

The collector voltage applying circuit 23 is connected to an interconnection line. CL coupled to the collector electrode 18 and the signal line 100c of the signal control circuit 100. The collector voltage applying circuit 23 alternately applies the positive first voltage Vc (first collector voltage V1) and the second voltage (the second collector voltage V2, which is the ground voltage, 0 V, in this embodiment) smaller than the first voltage Vc to the interconnection line CL based on the signal fed from the signal control circuit 100.

The operation of the circuit having the above-described structure will now be described. At initiation of the charge accumulation period Td starting at a particular time, the row selection circuit 21a outputs a selection signal Ss (50 V) to the row selection line LL1 of the first row based on the control signal from the signal control circuit 100 and outputs non-selection signals Sn (0 V) to the rest of the row selection lines LL. As this time, the row selection circuit 21a sets the rate of change in voltage for the selection signal Ss supplied to the row selection line LL1 to a predetermined value (|dV/dt| or the predetermined rate of change in voltage) β. In particular, the row selection circuit 21a gradually increases the voltage from 0 V to 50 V at a rate β of change in voltage and applies to the row selection line the selection signal Ss, which is the voltage maintained at 50 V. As a result, the potential of the lower electrodes 12 of the elements D11, D12, D13, . . . and D1m in the first row becomes the voltage (50 V) of the selection signal Ss. The potential of the lower electrodes 12 of the other elements, for example, the elements D21, D22, . . . and D2m in the second row and the elements D31, D32, . . . and D3m in the third row, becomes the voltage (0 V) of the non-selection signal Sn.

At this time, the signal supplying circuit 21c outputs pixel signals Sd (0 V, 30 V, or 50 V In this case) to the pixel signal lines UL (UL1, UL2 . . . and ULm) based on the control signal from the signal control circuit 100. The pixel signals Sd correspond to the luminance level of the respective pixels constituted from the elements of the selected row, i.e., in this case, the elements D11, D12, D13, . . . and D1m In the first row.

For example, assuming that a 0-V pixel signal Sd is supplied to the pixel signal line UL1, the element voltage Vin(D11) of the upper electrode 14 of the element D11 with respect to the lower electrode 12 of the same element becomes eventually (converges on) the aforementioned negative predetermined voltage Vm, i.e., −50 V(=0 V−50V). A large number of electrons are thus accumulated in the emitter section 13 near the upper electrode 14. Assuming that a 30-V pixel signal Sd is supplied to the pixel signal line UL2, the element voltage Vka(D12) of the upper electrode 14 of the element D12 with respect to the lower electrode 12 of the same element converge on the aforementioned negative predetermined voltage Vm, i.e., −20 V (=30 V−50 V). As a result, fewer electrons are stored in the emitter section 13 of the element D12 near the upper electrode 14 than in the element D11.

Note that, since the selection signal Ss is a voltage that gradually increases from 0 V to 50 V at a rate β of change in voltage, the drive voltage Vin applied to these elements gradually decreases toward the first voltage Vm, i.e., the negative predetermined voltage, and is then maintained at the first voltage Vm.

Assuming that a 50-V pixel signal Sd is supplied to the pixel signal line UL3, the element voltage Vka(D13) of the element D13 is 0 V (=50 V−50 V). Thus, no electrons are accumulated in the emitter section 13 of the element D13, and no polarization reversal occurs in the emitter section 13 of the element D13.

When the row selection period Ts (the period sufficient for accumulating electrons in the selected element, e.g., the period from the time t6 to the time t10 shown In FIG. 22) elapses, the row selection circuit 21a outputs the selection signal Ss (a voltage gradually increasing from 0 V to 50 V at a rate β) to the row selection line LL2 for the second row based on the control signal fed from the signal control circuit 100 and output the 0-V non-selection signals Sn to the rest of the row selection lines LL. By this operation, the potential of the lower electrodes 12 of the elements D21, D22, D23, . . . and D2m in the second row becomes the voltage (50 V) of the selection signal Ss. The potential of the lower electrodes 12 of the rest of the elements (e.g., the elements D11 to D1m in the first row and the elements D31 to D3m in the third row) becomes the voltage (0 V) of the non-selection signals Sn.

Meanwhile, the signal supplying circuit 21c outputs pixel signals Sd (0 V, 30 V, or 50 V in this embodiment) to the pixel signal lines UL (UL1, UL2, . . . and ULm) based on the control signal from the signal control circuit 100. The pixel signals Sd correspond to the luminance levels of the respective pixels constituted from the elements of the selected row, i.e., in this case, the elements D21, D22, D23, . . . and D2m in the second row. As a result, electrons are accumulated in the emitter sections of the elements D21, D22, D23, . . . and D2m in the second row, in amounts corresponding to the pixel signals Sd.

Note that the element voltage Vka of each element having the lower electrode with a 0-V non-selection signal Sn applied thereto is 0 V (the potential of the upper electrode: 0 V, the potential of the lower electrode: 0 V), 30 V (the potential of the upper electrode: 30 V, the potential of the lower electrode: 0 V), or 50 V (the potential of the upper electrode: 50 V, the potential of the lower electrode: 0 V). However, this level of voltage does not cause polarization reversal in the element in which the electrons are already accumulated and thus does not cause electron emission from that element.

The drive voltage Vin for the element connected to the row selection line LL1 to which the selection signal Ss is applied until immediately before the selection signal Ss is output to the row selection line LL2 is a voltage in the range of −50 V to 0 V. The drive voltage Vin for that element at the time the selection signal Ss is started to be supplied to the row selection line LL2 is thus 0 to 50 V. When the status of the element changes from “selected” to “not selected” as described, the drive voltage Vin applied to that element increases at a relatively high rate γ of change.

When the next row selection period Ts elapses, the row selection circuit 21a outputs a selection signal Ss (a voltage gradually increasing from 0 V to 50 V at a rate β) to the raw selection line LL3 (not shown) of the third row based on the control signal and outputs 0-V non-selection signals Sn to the rest of the row selection lines LL. Meanwhile, the signal supplying circuit 21c outputs pixel signals Sd corresponding to the luminance levels of the respective pixels constituted from the elements in the selected third row to the pixel signal lines UL. Such an operation is repeated every row selection time Ts until all of the rows are selected. As a result, at a predetermined time point, electrons are accumulated in the emitter sections of all the elements in amounts (including zero) corresponding to the luminance levels of the respective elements. This summarizes the operation that takes place during the charge accumulation period Td.

In order to start the emission period Th, the row selection circuit 21a applies a large negative voltage (the difference, i.e., −350 V, between the +50 V generated by the power circuit 110 and −400 V generated by the pulse generator 21b) to all of the row selection lines LL. Here, the row selection circuit 21a applies a voltage gradually decreasing to −350 V at a rate α of change to every row selection line LL. As a result, the potential of the lower electrode 12 of each element gradually changes toward the large negative voltage (−350 V). Meanwhile, the signal supplying circuit 21c outputs the reference voltage (0 V), which is generated by the pulse generating circuit 21c1 and supplied through the amplitude modulator circuit 21c2, to all of the pixel signal lines UL without modulation. The potential of the upper electrodes 14 of all the elements becomes the reference voltage (0 V).

Consequently, the drive voltage Vin applied to every element gradually changes toward the second voltage Vp (350 V), which is the positive predetermined voltage, at a rate a of change. Thus, polarization reversal occurs again and electrons accumulated in the emitter section 13 of each element are simultaneously emitted by Coulomb repulsion. This causes the phosphors above the elements to emit light and to thereby display images. Note that the emitter section of the element to which a zero drive voltage Vin is applied during the charge accumulation period Td does not have accumulated electrons and thus no polarization reversal occurs in this element. Thus, no polarization reversal occurs even when the interelectrode voltage (drive voltage) Vin is turned to a large positive voltage. Thus, for example, the element that is not required to emit light for the purpose of producing a particular image at a particular timing does not consume excess energy that accompanies the polarization reversal.

As is described above, during the charge accumulation period Td, the drive voltage applying circuit 21 consecutively sets the drive voltage Vin for the plurality of elements toward the first voltage (the negative predetermined voltage) Vm one after next. Upon completion of electron accumulation in all the elements, the drive voltage applying circuit 21 simultaneously sets the drive voltage Vin for all the elements at the positive predetermined voltage Vp so as to cause simultaneous electron emission from all of the elements to initiate the emission period Th. After the predetermined emission period Th has elapsed, the drive voltage applying circuit 21 again starts the charge accumulation period Td.

It should be noted that the rates α and β of change in voltage described above are each set to a value smaller than the rate γ of change in voltage. Thus, light emission due to unnecessary or excessive electron emission during the emission period Th can be avoided, and light emission due to unnecessary or excessive electron emission during the electron accumulation period Td can be avoided.

When the charge accumulation period Td is resumed after the emission period Th, the drive voltage Vin applied to each element may be rapidly decreased from the second voltage Vp to a third voltage Vn (which is a voltage between the first voltage Vm and the second voltage Vp) that does not cause electron accumulation in any element at a rate γ of change and may be maintained at the third voltage Vn for a predetermined period before the operation for the charge accumulation period Td is resumed.

In this circuit example, since a predetermined voltage (Vs) is applied to each focusing electrode, the electrons emitted from the upper electrode 14 only reach the phosphor directly above the upper electrode 14. Thus, a sharp image can be produced.

The collector voltage applying circuit 23 turns off the collector electrode 18 at a particular time point between “the time point at which electron emission from all of the elements is substantially completed first” and “the time point at which the drive voltage Vin of the element in which the electrons are accumulated fastest starts to decrease toward the first voltage Vm”. By this operation, the collector electrode 18 is turned off before the charge accumulation period Td of all the elements is started.

The collector voltage applying circuit 23 turns on the collector electrode 18 at a particular time “after the electron accumulation Is completed in the element in which the drive voltage Vin is changed to the first voltage Vm the latest among the elements during the charge accumulation period Td” and “before the next substantial completion of electron emission from all of the elements”.

As described above, in this electron emitting apparatus 10, no element accumulates electrons when other elements are emitting electrons. Thus, the electron emitting apparatus 10 having the plurality of elements can suppress unnecessary electron emission and impart energy to electrons normally (properly) emitted merely by switching between the ON status and the OFF status of the collector electrode 18 using the collector voltage applying circuit 23. Thus, the collector voltage applying circuit 23 becomes less expensive and simpler.

### Second Embodiment

An electron-emitting apparatus according to a second embodiment of the present invention will now be described. The second embodiment differs from the first embodiment only in that the drive voltage Vin (interelectrode voltage) is changed in a different manner from that in the electron-emitting apparatus 10 of the first embodiment. The description below mainly concerns this difference.

The drive voltage applying circuit 21 of the second embodiment has an element voltage measuring circuit, a first detector circuit for detecting completion of positive-side polarization reversal, and a second detector circuit for detecting completion of negative-side polarization reversal, although these components are not shown in the drawing. The element voltage measuring circuit monitors the element voltage Vka.

The first detector circuit for detecting the completion of the positive-side polarization reversal monitors the waveform of the element voltage Vka measured with the element voltage measuring circuit and detects, as the time point at which the positive-side polarization reversal is completed, a time point at which the rate of change In element voltage Vka over time (i.e., dVka/dt) starts to increase rapidly (i.e., dVka/dt exceeds the predetermined value) after the rate of change in element voltage Vka over time (i.e., dVka/dt) becomes smaller than a predetermined value when the element voltage Vka reaches the voltage around the positive coercive field voltage Vd.

Similarly, the second detector circuit for detecting the completion of the negative-side polarization reversal monitors the waveform of the element voltage Vka measured with the element voltage measuring circuit, and detects, as the time point at which the negative-side polarization reversal is completed, a time point at which the absolute value of the rate of change in element voltage Vka over time, i.e., |dVka/dt|, starts to increas rapidly after the absolute value of the rate of change in element voltage Vka over time, i.e., |dVka/dt| becomes smaller than a predetermined value when the element voltage Vka becomes around the negative coercive field voltage.

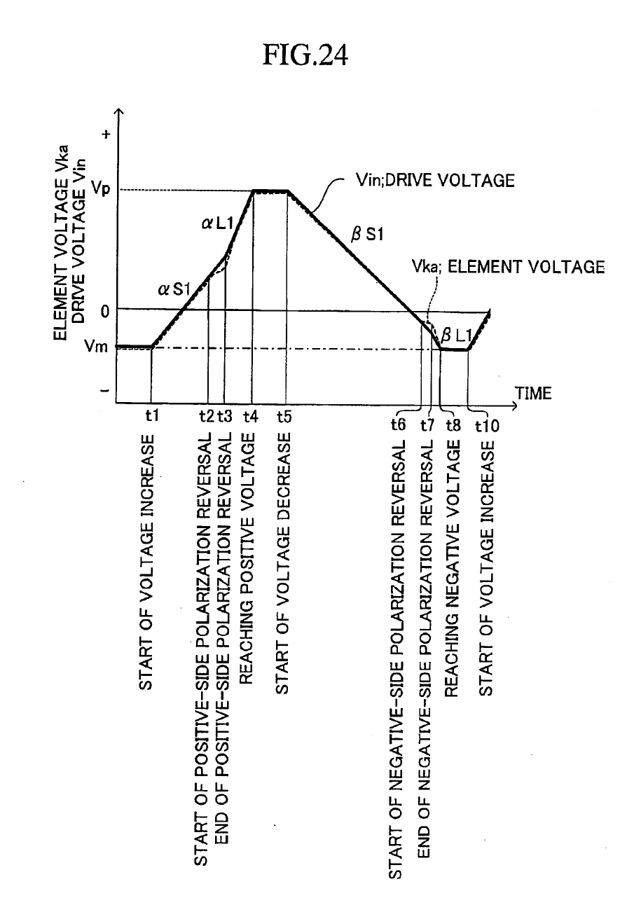

Referring to FIG. 24, during the period (voltage increasing period) between the time t1 at which the voltage is started to Increase and the time t4 at which the drive voltage Vin reaches the second voltage Vp, which is the positive predetermined voltage, the drive voltage applying circuit 21 (in particular, the power supply 21s) gradually increases the drive voltage Vin from the first voltage Vm, which is the negative predetermined voltage. In this period, the power supply 21s generates the drive voltage Vin that gradually increases from the time t1 (the start of voltage increase) at a rate (inclination) αS1 of change in voltage. When the completion of the positive-side polarization reversal (the time t3) is detected with the first detector circuit, the power supply 21s generates the drive voltage Vin gradually increasing at a rate (inclination) αL1 of change in voltage which is larger than αS1 toward the second voltage Vp from the time t3 to the time t4 at which the drive voltage Vin reaces the positive predetermined voltage.

By this operation, within the voltage increasing period (the time t1 to time t4), the drive voltage Vin shows the slowest increase from the time t1 (start of voltage increase) to the time t3 (completion of the positive-side polarization reversal).

During the period from the time t1 at which the drive voltage Vin is started to increase and the time t3 at which the polarization reversal in the emitter section 13 is substantially completed, the inrush current caused by the change in drive voltage Vin reaches the maximum. Thus, as in this embodiment, when the drive voltage Vin is increased most slowly from the time t1 (start of voltage increase) to the time t3 (completion of the positive-side polarization reversal), the inrush current flowing in the emitter section 13 can be effectively reduced. Thus, unnecessary electron emission due to the inrush current can be avoided. From the time t3 (completion of the positive-side polarization reversal) to the time t4 at which the drive voltage Vin reaches the predetermined positive voltage, the drive voltage Vin Is gradually increased at a relatively high rate αL1 of change. Thus, the entire length of the voltage increasing period (the period in which a voltage operation to emit electrons is carried out) can be decreased.

Furthermore, as seen in FIG. 24, the drive voltage applying circuit 21 (the power supply 21s) generates the drive voltage Vin gradually decreasing from the positive predetermined voltage, i.e., the second voltage Vp during the period (voltage decreasing period) from the time t5 at which the voltage starts to decrease to the time t8 at which the drive voltage Vin reaches a target negative voltage, i.e., the first voltage Vm. Here, the power supply 21s generates the drive voltage Vin gradually decreasing at a rate (inclination) βs1 (βs1>0) of change from the time t5. When the completion of the negative-side polarization reversal is detected with the second detector circuit at the time t7, the power supply 21s generates the drive voltage Vin gradually decreasing toward the first voltage Vm at a rate βL1 (βL1>0) of change which is larger than βS1 until the time t8 at which the the drive voltage Vin reaches the target negative voltage.

By this operation, in the drive voltage Vin decreasing period (t5 to t8), the drive voltage Vin shows the slowest decrease between the time t5 at which the voltage starts to decrease till the time t7 at which the negative-side polarization reversal is completed.

During the period from the time t5 at which the drive voltage Vin starts to decrease to the time t7 at which the negative-side polarization reversal in the emitter section 13 is substantially completed, the inrush current due to the change in drive voltage Vin reaches the maximum. Thus, as in this embodiment, by decreasing the drive voltage Vin most slowly from the time t5 (start of voltage decrease) to the time t7 (completion of the negative-side polarization reversal), the inrush current flowing in the emitter section 13 can be effectively reduced. As a result, unnecessary electron emission due to inrush current can be avoided. From the time t7 at which the negative-side polarization reversal is completed to the time t8 at which the drive voltage Vin reaches the target negative voltage, the drive voltage Vin is gradually decreases at a relatively high rate βL1 of change. Thus, the entire length of the voltage decreasing period (the period in which a voltage operation to accumulate electrons) can be reduced.

### Third Embodiment

An electron-emitting apparatus according to a third embodiment of the present invention will now be described. The third embodiment differs from the second embodiment only in the manner the drive voltage Vin (interelectrode voltage) is changed. The description below mainly concerns this difference.

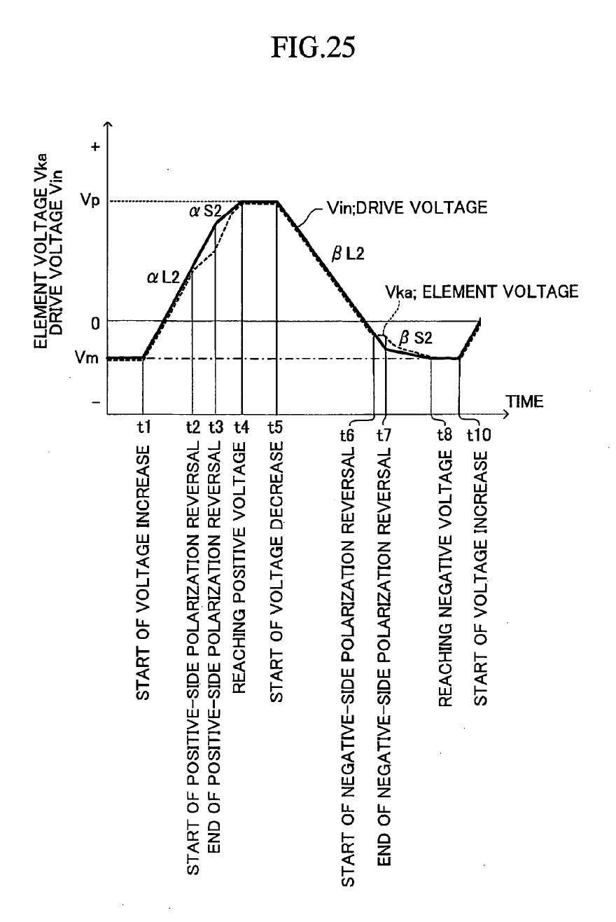

In the third embodiment, the power supply 21s of the drive voltage applying circuit 21 generates the voltage indicated in FIG. 25, and the drive voltage applying circuit 21 applies this voltage functioning as the drive voltage Vin between the upper electrode 14 and the lower electrode 12.

In detail, referring to FIG. 25, the drive voltage applying circuit 21 (power supply 21s) gradually increases the drive voltage Vin from the first voltage Vm, i.e., the negative predetermined voltage, during the period (voltage increasing period) from the time t1 at which the voltage starts to increase to the time t4 at which the drive voltage Vin reaches the positive predetermined voltage, i.e., the second voltage Vp. From the time t1, the power supply 21s generates the drive voltage Vin gradually increasing at a rate (inclination) αL2. When the completion of the positive-side polarization reversal (i.e., the time t3) is detected with the first detector circuit, the power supply 21s generates the drive voltage Vin gradually increasing toward the second voltage Vp at a rate αS2 which is smaller than αL2 until the time t4 at which the drive voltage Vin reaches the positive predetermined voltage.

By this operation, within the voltage increasing period (t1 to t4), the drive voltage Vin shows the slowest increase from the time t3 at which the positive-side polarization reversal is completed to the time t4 at which the positive predetermined voltage is reached.

In some elements by themselves or other elements with some measures to avoid unnecessary electron emission, unnecessary electron emission due to a rapid change in element voltage Vka upon completion of the positive-side polarization reversal occurs more frequently than the unnecessary electron emission due to the inrush current that occurs at the start of increasing the interelectrode voltage (drive voltage) Vin. Thus, as in this embodiment, when the rate of increase in the drive voltage Vin is adjusted to be lowest from the time t3 (completion of the positive-side polarization reversal) to the time t4 (reaching the predetermined positive voltage), unnecessary electron emission can be effectively avoided. From the time t1 (start of the voltage increase) to the time t3 (completion of the positive-side polarization reversal), the drive voltage Vin can be gradually increased at a relatively high rate αL2. Thus, the entire length of the voltage increasing period (the period in which a voltage operation to emit electrons is carried out) can be reduced as a whole.

Again referring to FIG. 25, the drive voltage applying circuit 21 (power supply 21s) generates the drive voltage Vin gradually decreasing from the second voltage Vp (positive predetermined voltage) during the period (voltage decreasing period) from the time t5 at which the voltage starts to decrease till the time t8 at which the drive voltage Vin reaches the first voltage Vm, which is the target negative voltage. From the time t5 at which the voltage starts to decrease, the power supply 21s generates the drive voltage Vin gradually decreasing at a rate (inclination) βL2 (βL2>0). When the completion of the negative-side polarization reversal is detected with the second detector circuit (the time t7), the power supply 21s generates the drive voltage Vin gradually decreasing toward the first voltage Vm at a rate βS2 (βS2>0) smaller than βL2 until the time t8 at which the drive voltage Vin reaches the target negative voltage.

By this operation, within the voltage decreasing period (the time t5 to the time t8), the drive voltage Vin is decreased at the lowest rate during the period from the time t7 at which the negative-side polarization reversal is completed to the time t8 at which the drive voltage Vin reaches the target negative voltage.

In some elements by themselves or other elements with some measures to avoid unnecessary electron emission, unnecessary electron emission due to a rapid change in element voltage Vka upon completion of the negative-side polarization reversal occurs more frequently than the unnecessary electron emission due to the inrush current that occurs at the start of decreasing the drive voltage Vin. Thus, by most slowly decreasing the drive voltage Vin from the time t7 at which the negative-side polarization reversal is completed till the time t8 at which the drive voltage Vin reaches the target negative voltage, unnecessary electron emission can be effectively avoided. Since the drive voltage Vin is decreased at a relatively high rate βL2 from the time t5 to the time t7 at which the negative-side polarization reversal is completed, the entire length of the voltage decreasing period (the period in which a voltage operation to accumulate electrons) can be reduced.

### Fourth Embodiment

An electron-emitting apparatus according to a fourth embodiment of the present invention will now be described. The fourth embodiment differs from the electron-emitting apparatus 10 of the first embodiment only in the manner the drive voltage Vin is changed. Thus, the description below mainly concerns this difference.

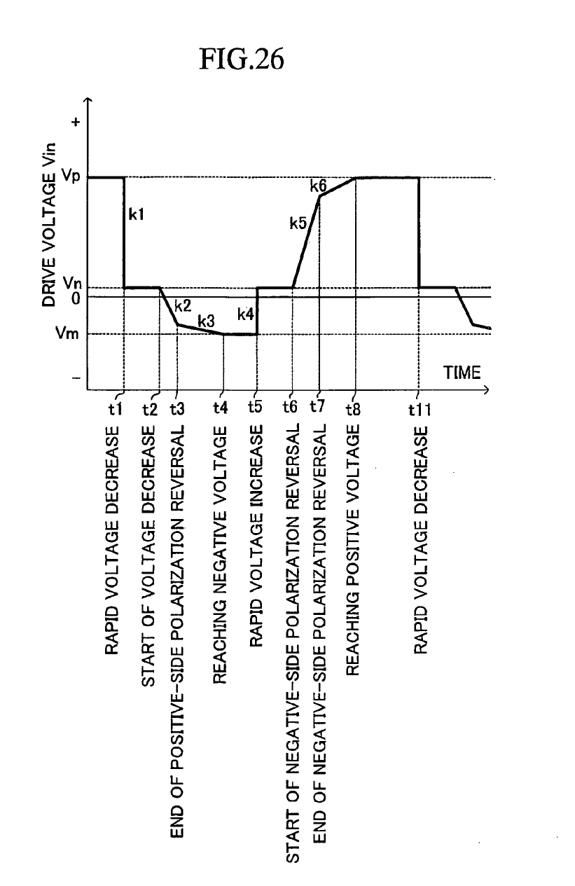

In the fourth embodiment, the power supply 21s of the drive voltage applying circuit 21 generates the voltage shown in FIG. 26, and the drive voltage applying circuit 21 applies this voltage as the drive voltage Vin between the upper electrode 14 and the lower electrode 12.

In detail, referring to FIG. 26, at the time t1, the drive voltage applying circuit 21 (power supply 21s) generates the drive voltage Vin rapidly decreasing at a rate (inclination) k1 from the second voltage Vp to the third voltage Vn. Subsequently, the power supply 21s maintains the third voltage Vn, as the drive voltage Vin, from the time t1 until the time t2 (a particular time after the time t1) at which the voltage is started to decrease.

The third voltage Vn is an intermediate voltage between the first voltage Vm, which is the negative predetermined voltage, and the second voltage Vp, which is the positive predetermined voltage, as described above. The third voltage Vn is a voltage that does not cause electron accumulation (or additional electron accumulation) in or electron emission from the emitter section 13 when the element voltage Vka is coincident with the third voltage Vn.

Subsequently, at the time t2 at which the voltage is started to decrease, the power supply 21s generates the drive voltage Vin decreasing from the third voltage Vn at a rate k2 of change. At the time t3, which is presumably the time that the negative-side polarization reversal is completed and is a predetermined time after the time t2, the power supply 21s generates the drive voltage Vin decreasing from the drive voltage Vin at the time t3 at a rate k3 of change until the time t4 at which the drive voltage Vin reaches the target negative voltage, i.e., the first voltage Vm.

From the time t4 to the time t5, the power supply 21s maintains the drive voltage Vin at the first voltage Vm. At the time t5, the power supply 21s generates the drive voltage Vin rapidly increasing from the first voltage Vm to the third voltage Vn at a rate (inclination) k4 of change. Subsequently, the power supply 21s maintains the third voltage Vn from the time t5 to the time t6, which is a predetermined time after the time t5 and which is a time point at which the voltage is started to increase.

At the time t6 at which the voltage starts to increase, the power supply 21s generates the drive voltage Vin Increasing from the third voltage Vn at a rate k5. At the time t7 which is a predetermined time after the time t6 (start of voltage increase) and is presumably the time at which the positive-side polarization reversal is completed, the power supply 21s generates the drive voltage Vin increasing from the voltage level at the time t7 at a rate K6 of change until the drive voltage Vin reaches the second voltage Vp at the time t8. Thereafter, the power supply 21s repeats generation of voltages at the time t1 to the time t8.

In this embodiment, the relationship k3<k2<k1 is set. That is, after the power supply 21s generates the second voltage Vp, the power supply 21s generates a voltage decreasing from the second voltage Vp toward the third voltage Vn at the time ti so that the voltage is maintained at a level that does not cause electron accumulation or electron emission in or from the emitter section 13, the voltage level being between the negative predetermined voltage and the positive predetermined voltage described above. Subsequently, from the time t2 to the time t4, the power supply 21s generates the voltage which decreases from the third voltage Vn toward the first voltage Vm more slowly compared with the decrease in voltage from the second voltage Vp to the third voltage Vn which takes place at the time t1. According to an experiment, the rapid change in drive voltage Vin from the second voltage Vp to the third voltage Vn did not cause unnecessary electron emission. Thus, according to this embodiment, the drive voltage Vin that changes slowly from the third voltage Vn to the first voltage Vm is applied to the element. Therefore, unnecessary electron emission can be avoided while reducing the entire time required for the electron accumulation after the electron emission.

Furthermore, in this embodiment, the relationship k6<k5<k4 is set. In other words, after the power supply 21s generates the first voltage Vm, the power supply 21s generates the voltage increasing from the first voltage Vm to the third voltage Vn so that the voltage is maintained at a level that does not cause electron accumulation in or electron emission from the emitter section 13, the voltage level being between the negative predetermined voltage and the positive predetermined voltage described above. Subsequently, the power supply 21s generates the voltage which increases from the third voltage Vn to the second voltage Vp more slowly compared with the increase in voltage from the first voltage Vm to the third voltage Vn (time t6). According to an experiment, the rapid change in drive voltage Vin from the first voltage Vm to the third voltage Vn did not cause unnecessary electron emission. Moreover, in this embodiment, the drive voltage Vin slowly changing from the third voltage Vn to the second voltage Vp is applied to the element. Thus, unnecessary electron emission can be avoided while reducing the entire time required for the electron emission after the electron accumulation.

It is to be understood that the relationship k2≦k3≦k1 or k5≦k6<k4 may be alternatively used. That is, the relationships between k2 and k3 and between k5 and k6 can be suitably determined based on the properties of the element, e.g., at which point of time the unnecessary electron emission takes place.

Alternatively, as with the embodiments afore-mentioned, the element voltage Vka may be monitored, the time t3 at which the negative-side polarization reversal is completed may be detected when the element voltage Vka is below the voltage corresponding to the negative coercive field voltage, and/or the time t7 at which the positive-side polarization reversal is completed may be detected when the element voltage Vka is above the voltage corresponding the positive coercive field voltage so that the rates of change in drive voltage Vin at the respective time points may be adjusted as described above.

### Fifth Embodiment

An electron-emitting apparatus according to a fifth embodiment of the present invention will now be described. The fifth embodiment differs from the fourth embodiment only in that the drive voltage Vin of the electron-emitting apparatus is changed stepwise. Thus, the description below mainly concerns this difference.

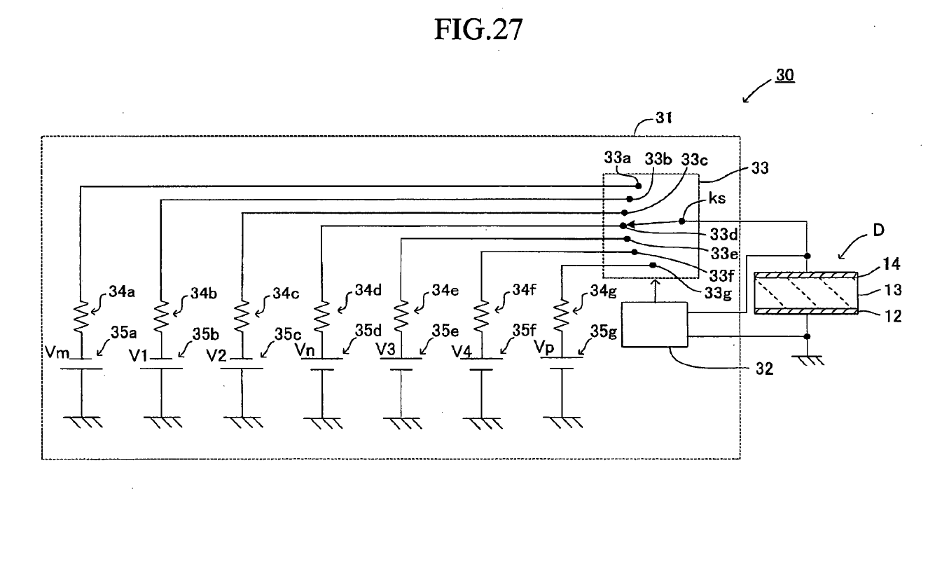

Referring to FIG. 27, an electron-emitting apparatus 30 of the fifth embodiment includes an element D and a drive voltage applying circuit 31. The element D is the same as the element in the first embodiment. In the drawing, the transparent plate 17, the collector electrode 18, and the phosphor 19 are omitted. The lower electrode 12 of the element D is earthed.

The drive voltage applying circuit 31 has a voltage control circuit 32, a switching circuit 33, a plurality of resistors 34a to 34g, and a plurality of constant voltage sources 35a to 35g.

The voltage control circuit 32 is connected to the lower electrode 12 and the upper electrode 14 of the element D and the switching circuit 33. The voltage control circuit 32 measures the element voltage Vka and sends a switching signal to the switching circuit 33 based on the observed (measured) element voltage Vka.

The switching circuit 33 has a fixed connection point ks connected to the upper electrode 14 of the element D and a plurality of (in this embodiment, seven) connecting points 33a to 33g for voltage application. The switching circuit 33 selects one of the connecting points 33a to 33g in response to the switching signal fed from the voltage control circuit 32, and connects the fixed connection point ks to the selected connecting point for voltage application.

The connecting point 33a is connected to a first end of the resistor 34a. A second end of the resistor 34a is connected to the cathode of the constant voltage source 35a generating a voltage |Vm| (the same voltage as the first voltage Vm). The anode of the constant voltage source 35a is earthed. The connecting point 33b is connected to a first end of the resistor 34b. A second end of the resistor 34b is connected to the cathode of the constant voltage source 35b generating a voltage |V1|. The anode of the constant voltage source 35b is earthed. The connecting point 33c is connected to a first end of the resistor 34c. A second end of the resistor 34c is connected to the cathode of the constant voltage source 35c generating a voltage |V2|. The anode of the constant voltage source 35c is earthed. The relationship |V1|<|V2|<|Vm| (Vm<0) is established here.

The connecting point 33d is connected to a first end of the resistor 34d. A second end of the resistor 34d is connected to the anode of the constant voltage source 35d generating the third voltage Vn described above. The cathode of the constant voltage source 35d is earthed. The connecting point 33e is connected to a first end of the resistor 34e. A second end of the resistor 34e is connected to the anode of the constant voltage source 35e generating a voltage V3. The cathode of the constant voltage source 35e is earthed. The connecting point 33f is connected to a first end of the resistor 34f. A second end of the resistor 34f is connected to the anode of the constant voltage source 35f generating a voltage V4. The cathode of the constant voltage source 35f is earthed. The connecting point 33g is connected to a first end of the resistor 34g. A second end of the resistor 34g is connected to the anode of the constant voltage source 35g generating the second voltage Vp described above. The cathode of the constant voltage source 35g is earthed. The relationship 0<Vn<V3<V4 <Vp is established here.

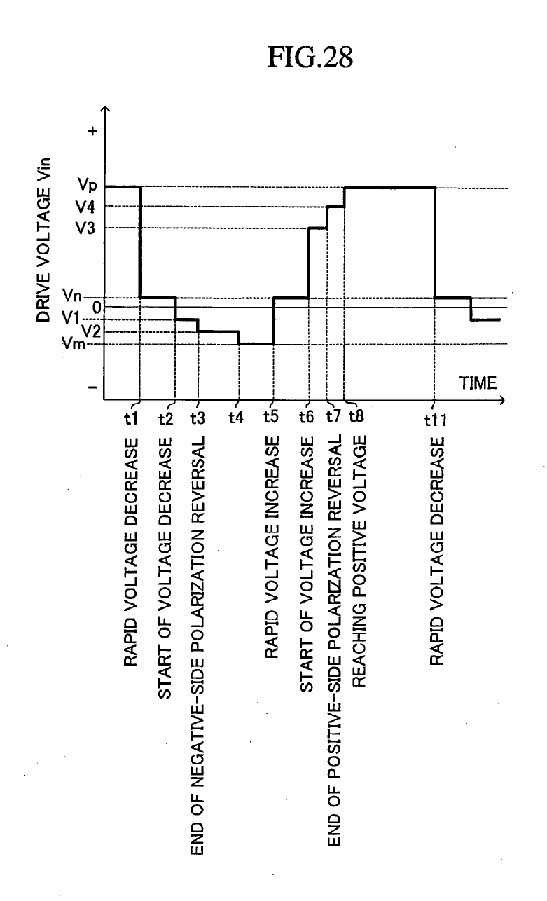

The operation of the drive voltage applying circuit 31 having the above-described configuration will now be described with reference to FIG. 28. Assume that before the time t1, the switching circuit 33 connects the fixed connection point ks to the connecting point 33g for voltage application and thus, the second voltage Vp (Vp>0) is applied to the element D. At the time t1, the voltage control circuit 32 sends a switching signal to the switching circuit 33, and the switching circuit 33 connects the fixed connection point ks to the connecting point 33d in response to this signal. As a result, the drive voltage applying circuit 31 generates the third voltage Vn as the drive voltage Vin. In other words, at the time t1, the drive voltage Vin decreases from the second voltage Vp to the third voltage Vn at a relatively high rate of change in voltage.

After a predetermined time after the time t1, the voltage control circuit 32 sends a switching signal to the switching circuit 33, and the switching circuit 33 connects the fixed connection point ks to the connecting point 33b in response to the signal at the time t2. As a result, the drive voltage applying circuit 31 generates the voltage V1 (V1<0) as the drive voltage Vin. Subsequently, the voltage control circuit 32 monitors the element voltage Vka, assumes (detects) completion of the negative-side polarization reversal when the element voltage Vka is below the negative coercive field voltage, and sends a switching signal to the switching circuit 33, when the completion of the negative-side polarization reversal is detected. In response to this signal, the switching circuit 33 connects the fixed connection point ks to the connecting point 33c. The drive voltage applying circuit 31 thus generates the voltage V2 (V2<0) as the drive voltage Vin at the time t3.

A predetermined time after the time t3, i.e., at the time t4, the voltage control circuit 32 sends a switching signal to the switching circuit 33, and the switching circuit 33 connects the fixed connection point ks to the connecting point 33a in response to this signal. As a result, the drive voltage applying circuit 31 generates the first voltage Vm (Vm<0) as the drive voltage Vin. After a predetermined time from the time t4 and until the time t5, the drive voltage applying circuit 31 continues generation of the first voltage Vm as the drive voltage Vin. The element voltage Vka thus reaches the negative predetermined voltage in the period from the time t2 to the time t5. In other words, the electron accumulation in the emitter section 13 is completed within this period.

At the time t5, the voltage control circuit 32 sends a switching signal to the switching circuit 33, and the switching circuit 33 connects the fixed connection point ks to the connecting point 33d in response to this signal. The drive voltage applying circuit 31 thus generates the third voltage Vn (Vn>0) as the drive voltage Vin. That is, at the time t5, the drive voltage Vin changes from the first voltage Vm to the third voltage Vn at a relatively high rate of change in voltage.

After a predetermined time from the time t5, at the time t6, the voltage control circuit 32 sends a switching signal to the switching circuit 33, and the switching circuit 33 connects the fixed connection point ks to the connecting point 33e in response to this signal. The drive voltage applying circuit 31 thus generates the voltage V3 (V3>0) as the drive voltage Vin. Subsequently, the voltage control circuit 32 monitors the element voltage Vka, assumes (detects) completion of the positive-side polarization reversal when the element voltage Vka is above the positive coercive field voltage, and sends a switching signal to the switching circuit 33 when the completion of the positive-side polarization reversal is detected. The switching circuit 33 connects the fixed connection point ks to the connecting point 33f in response to this signal. The drive voltage applying circuit 31 thus generates the voltage V4 (V4>0) as the drive voltage Vin at the time t7.

After a predetermined time from the time t7, at the time t8, the voltage control circuit 32 sends a switching signal to the switching circuit 33, and the switching circuit 33 connects the fixed connection point ks to the connecting point 33g in response to this signal. The drive voltage applying circuit 31 thus generates the second voltage Vp as the drive voltage Vin again. The drive voltage applying circuit 31 repeats the generation of the voltages at the time t1 to the time t8 from here on.

In the fifth embodiment, the constant voltage sources 35a to 35g and the switching circuit 33 functions as if they form one power supply. Thus, as with the power supply 21s of the fourth embodiment, the power supply of the fifth embodiment generates the second voltage Vp, and, at the subsequent time t1, generates a voltage decreasing from the second voltage Vp to the third voltage Vn so that the voltage is maintained at the level that does not cause electron accumulation or electron emission in or from the emitter section 13, the voltage level being between the negative predetermined voltage and the positive predetermined voltage described above. Moreover, from the time t2 to the time t4, the power supply generates a voltage (a voltage gradually decreasing to the first voltage Vm) that slowly decreases from the third voltage Vn toward the first voltage Vm when compared with the decrease from the second voltage Vp to the third voltage Vn that takes place at the time t1. Moreover, upon completion of the negative-side polarization reversal, the drive voltage Vin is gradually decreased. Thus, as with the fourth embodiment, the electron-emitting apparatus 30 of the fifth embodiment can avoid unnecessary electron emission during the electron accumulation and can reduce the time required for the electron accumulation from after the electron emission.

As with the power supply 21s of the fourth embodiment, the power supply of this embodiment generates the first voltage Vm, and then generates a voltage increasing from the first voltage Vm to the third voltage Vn so that the voltage Is maintained at a level that does not cause electron accumulation in or electron emission from the emitter section 13, the voltage level being between the negative predetermined voltage and the positive predetermined voltage described above. Subsequently, from the time t6 to the time t8, the power supply generates a voltage gradually and slowly increasing from the third voltage Vn to the second voltage Vp when compared with the increase from the first voltage Vm to the third voltage Vn (the time t5). In addition, the drive voltage Vin increases slowly also after the completion of the positive-side polarization reversal. Thus, the electron-emitting apparatus 30 can avoid unnecessary electron emission during the electron emission and reduce the time required for the electron emission from after the electron accumulation.

According to this embodiment, the power supply for generating drive voltage Vin that can avoid unnecessary electron emission can be provided by the above-described simple configuration of switching the constant voltage source using the switching circuit 33. With this drive voltage applying circuit 31, a simple power supply that can generate desired drive voltages Vin can be provided even when the properties of the elements are varied or even when the desired drive voltage Vin required for electron emission and accumulation changes with the change in the number of elements from which emission is required in the electron-emitting apparatus. Besides, since the element voltage Vka is monitored and the level of the drive voltage Vin is switched when the element voltage Vka is below the negative coercive field voltage or above the positive coercive field voltage, an appropriate level of the drive voltage Vin can be applied to the element at an appropriate timing even when the element voltage Vka is changed with changes in properties of the element or in number of the electrons emitted.

The resistances of the resistors 34a to 34g may be the same or different. The advantages of setting the resistances of the resistors 34a to 34g at appropriate levels (changing the circuit parameter) will be described below in the seventh embodiment. Note that in the fifth embodiment, seven constant voltage sources are provided. However, the number of the pairs of the constant voltage sources and the resistors may be lager so that the drive voltage Vin can be generated stepwise with a smaller step difference.

### Sixth Embodiment

An electron-emitting apparatus according to a sixth embodiment of the present invention will now be described. The sixth embodiment differs from the electron-emitting apparatus 10 of the first embodiment only in the manner in which the drive voltage (interelectrode voltage) Vin is changed. Thus, the description below mainly concerns this difference.

The drive voltage supplying circuit of the sixth embodiment has the element voltage measuring circuit and the second detector circuit for detecting the completion of the negative-side polarization reversal (not shown) included in the drive voltage applying circuit 21 of the second embodiment.

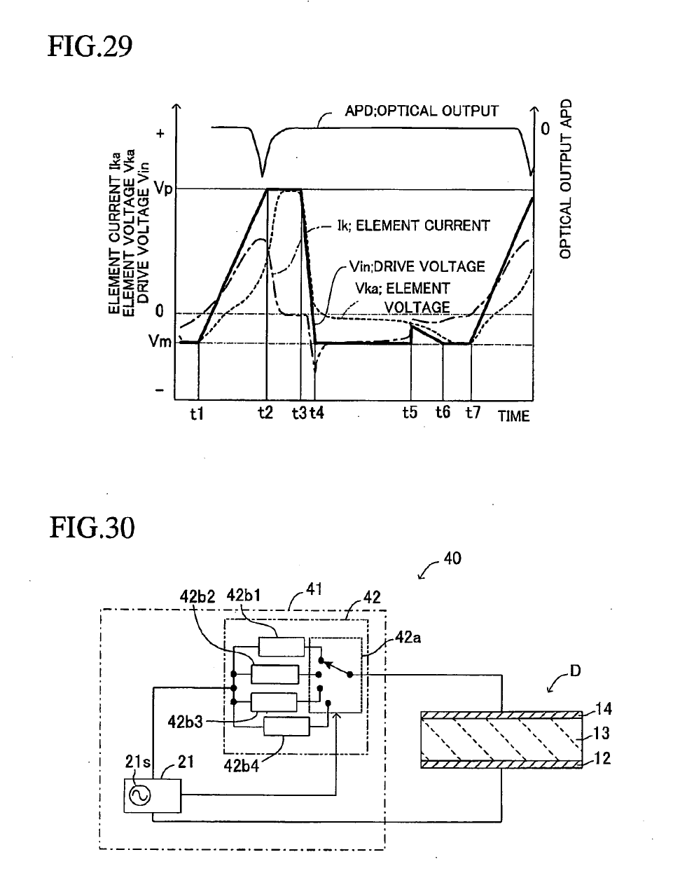

Referring to FIG. 29, as with the drive voltage applying circuit 21 of the first embodiment, the drive voltage applying circuit (power supply) generates the drive voltage Vin gradually increasing from the first voltage Vm (the negative predetermined voltage) to the second voltage Vp (the positive predetermined voltage) during the period (voltage increasing period) from the time t1 at which the voltage starts to increase to the time t2 at which the drive voltage Vin reaches the second voltage Vp. The drive voltage applying circuit also generates a drive voltage Vin gradually decreasing from the second voltage Vp to the first voltage Vm during the period (voltage decreasing period) from the time t3 at which the voltage is started to decrease to the time t4 at which the drive voltage Vin reaches the first voltage Vm. The drive voltage Vin to be reached at the time t4 is also referred to as the “fourth voltage” for the convenience sake.

When the second detector circuit detects the completion of the negative-side polarization reversal (the time t5) after the time t4, the drive voltage applying circuit rapidly increases the drive voltage Vin from the first voltage Vm to a fifth voltage at a rate α of change in voltage, and then gradually decreases the drive voltage toward the negative first voltage Vm at a rate β of change in voltage smaller than the rate α. Here, the absolute value of the first voltage (fourth voltage) Vm is larger than the absolute value of the fifth voltage. In other words, at the time the negative-side polarization reversal is substantially completed in the emitter section 13, the drive voltage Vin is caused to become a voltage near the element voltage Vka at this time point, i.e., the drive voltage Vin is controlled to a value near the negative coercive field voltage. Subsequently, the drive voltage applying circuit 21 gradually decreases the drive voltage Vin toward the first voltage Vm so that the drive voltage Vin reaches the first voltage Vm at the time t6. The rate of change in voltage during this period (from the time t5 to the time t6) is smaller than that in the period from the time t3 to the time t4 or at the time t5.

At the time t7 after the time t6, the drive voltage applying circuit 21 generates a voltage that increases the drive voltage Vin. After this time point, the drive voltage applying circuit repeats the generation of the voltages at the time t1 to the t7.

According to an experiment, upon completion of the negative-side polarization reversal, the element voltage Vka shows a steep change, and unnecessary electron emission is frequently observed. Thus, by changing the voltage generated by the power supply as in this sixth embodiment, the change in element voltage Vka upon completion of the negative-side polarization reversal can be moderated and unnecessary electron emission can be effectively avoided. Since the power supply generates the first voltage Vm until completion of the negative-side polarization reversal, the length of time from the time t3 at which the voltage starts to decrease to the time t5 at which the negative-side polarization reversal Is completed can be further reduced.

It can be said that the changes in drive voltage Vin after the negative-side polarization reversal, i.e., after the period from the time t5 to the time t6, are the same as an operation where the electrons from the upper electrode 14 are caused to be accumulated in the emitter section 13 by generating a voltage gradually decreasing toward the first voltage Vm so that the element voltage Vka reaches the negative predetermined value, after the electrons are caused to emitted from the emitter section 13 from the time t1 to the time t3 by changing the drive voltage Vin toward the second voltage Vp.

In this embodiment, the fourth voltage to be reached at the time t4 is set to the first voltage Vm. However, the fourth voltage is not limited to the first voltage Vm. The voltage to be reached at the time t4 may be any voltage that can cause negative-side polarization reversal in the emitter section.

In this embodiment, the power supply generates a voltage that changes from the fourth voltage to the fifth voltage at the completion of the negative-side polarization reversal (the time t5) and then gradually decreases toward the first voltage. Alternatively, the power supply may generate a voltage that changes from the fourth voltage to the fifth voltage after the t4 but before the completion of the negative-side polarization reversal (the time t5) and then gradually decreases toward the first voltage.

In this embodiment, from the time t4 at which the target negative voltage is reached to the time t5 of completion of the negative-side polarization reversal, the power supply generates a constant voltage, i.e., the fourth voltage (the first voltage Vm). Alternatively, the power supply may generate a voltage that changes in a negative voltage range whose absolute value Is larger than the absolute value of the fifth voltage. For example, a voltage that gradually changes from the fourth voltage toward the fifth voltage may be generated.

Furthermore, in this embodiment, from the time t3 at which the voltage starts to decrease to the time t4 at which the target negative voltage is reached, the power supply generates a voltage gradually decreasing toward the fourth voltage (first voltage Vm). Alternatively, the power supply may generate a voltage that immediately changes to the fourth voltage at the time t3.

### Seventh Embodiment

An electron-emitting apparatus according to a seventh embodiment of the present invention will now be described. The seventh embodiment differs from the second embodiment shown in FIG. 24 only in the circuit various parameters of the circuit for connecting the power supply 21s to the element are used. The description below thus mainly concerns this difference.

Referring to FIG. 30, an electron-emitting apparatus 40 of the seventh embodiment includes an element D constituted from the lower electrode 12, the emitter section 13, and the upper electrode 14; and a drive voltage applying circuit 41. The element D is the same as the element in the first embodiment, and the transparent plate 17, the collector electrode 18, and the phosphor 19 is omitted from the drawing. The drive voltage applying circuit 41 includes the drive voltage applying circuit 21 described above and a circuit parameter switching circuit (circuit parameter switching means) 42.

The circuit parameter switching circuit 42 is connected in series to (inserted in series into) the circuit for connecting the element D to the power supply 21s in the drive voltage applying circuit 21. The circuit parameter switching circuit 42 has a switching element 42a and a plurality of circuit elements (circuit parameter setting elements) 42b1, 42b2, 42b3, and 42b4.

The switching element 42a receives a control signal from the drive voltage applying circuit 21, and selectively connects the fixed connection point connected to the upper electrode 14 of the element D to one of the connecting points connected to the circuit elements 42b1, 42b2, 42b3, and 42b4 so that one of the circuit elements 42b1, 42b2, 42b3, and 42b4 is connected in series in (inserted in series into) the circuit. The circuit elements 42b1, 42b2, 42b3, and 42b4 have different resistances (resistance values).

Next, the operation of the electron-emitting apparatus 40 having the above-described structure is explained. As is previously stated, the electron-emitting apparatus 40 changes the drive voltage Vin in the same manner as the electron-emitting apparatus of the second embodiment.

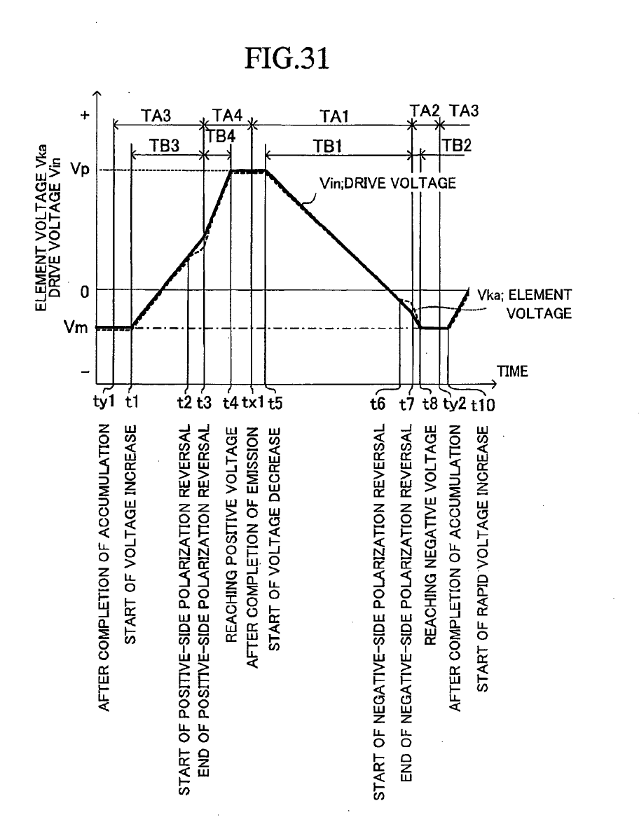

Now, referring to FIG. 31, in the electron-emitting apparatus 40, the switching element 42a connects the circuit element 42b1 to (inserts the circuit element.42b1 in series into) the circuit during a period TA1 from the time t4 (the time at which the target positive voltage is reached) or the time tx1 (the time immediately after electron emission is substantially completed) Immediately after the time t4, to the time t7 at which the negative-side polarization reversal is completed.

The electron-emitting apparatus 40 then connects the circuit element 42b2 to the circuit using the switching element 42a during a period TA2 from the time t7 at which the negative-side polarization reversal is completed to the time t8 at which the target negative voltage is reached or the time ty2 immediately after the completion of the electron accumulation which comes after the time t8.

The electron-emitting apparatus 40 then connects the circuit element 42b3 to (inserts the circuit element 42b3 in series into) the circuit using the switching element 42a during a period TA3 from the time of completion of the electron accumulation (i.e., the time ty2 and the time ty1 in FIG. 31 since the waveform of the drive voltage Vin is repeated) to the time of completion of the next positive-side polarization reversal (the time t3).

The electron-emitting apparatus 40 then connects the circuit element 42b4 to (inserts the circuit element 42b4 in series into) the circuit using the switching element 42a during a period TA4 from the completion of the positive-side polarization reversal (the time t3) to the completion of the electron emission (the time tx1). The electron-emitting apparatus 40 repeats the selecting and connecting of the circuit elements as described above.

In this manner, at least two (in this embodiment, all four) of the following circuit elements are different from each other:

a circuit element connected to (inserted in series into) the circuit during a first period TB1 from the time t5 to the time t7, the time t5 being the time at which generation of the voltage (drive voltage Vin) decreasing toward the first voltage Vm is started and the time t7 being the time at which the polarization reversal (the negative-side polarization reversal) in the emitter section 13 is substantially completed while the voltage is decreased;

a circuit element connected to (inserted in series into) the circuit during a second period TB2 from the time t7 to the time of completion of the electron accumulation between the time t8 to the time ty2, the time t7 being the time of completion of the negative-side polarization reversal;

a circuit element connected to (inserted in series into) the circuit during a third period TB3 from the time t1 to the time t3, the time t1 being the time at which generation of the voltage increasing toward the second voltage Vp is started and the time t3 being the time at which the positive-side polarization reversal In the emitter section 13 is substantially completed while the voltage is increased; and

a circuit element connected to (inserted in series into) the circuit during a fourth period TB4 from the time t3 of completion of the positive-side polarization reversal to the time at which the electron emission from the emitter section 13 is substantially completed between the time t4 to the time tx1.

In this embodiment, the circuit element (e.g., a resistor) connected to the circuit is selected for each period so that the circuit parameter during the period in which unnecessary electron emission is frequent due to the properties of the emitter section 13 of the element D differs from the circuit parameters during other periods. As a result, when compared with cases in which the circuit parameter is not changed, the time from the start of the electron accumulation to the completion of electron emission can be reduced while avoiding unnecessary electron emission.

In this embodiment, the drive voltage Vin is changed gradually. Alternatively, as shown in FIGS. 26 and 28, the drive voltage Vin may be a voltage that maintains the third voltage Vn for a particular length of time when the voltage is changing from the first voltage Vm to the second voltage Vp or vise versa. Alternatively, as shown in FIG. 41, the drive voltage Vin may be rectangular waves.

In this embodiment, the circuit elements 42b1, 42b2, 42b3, and 42b4 are resistors having different resistances. However, it is sufficient if at least two of these circuit elements have resistances different from each other. Moreover, the circuit elements may include, other than resistors, coils and capacitors. In such a case, at least two of the circuit elements 42b1, 42b2, 42b3, and 42b4 should have impedances Z different from each other.

### Eighth Embodiment

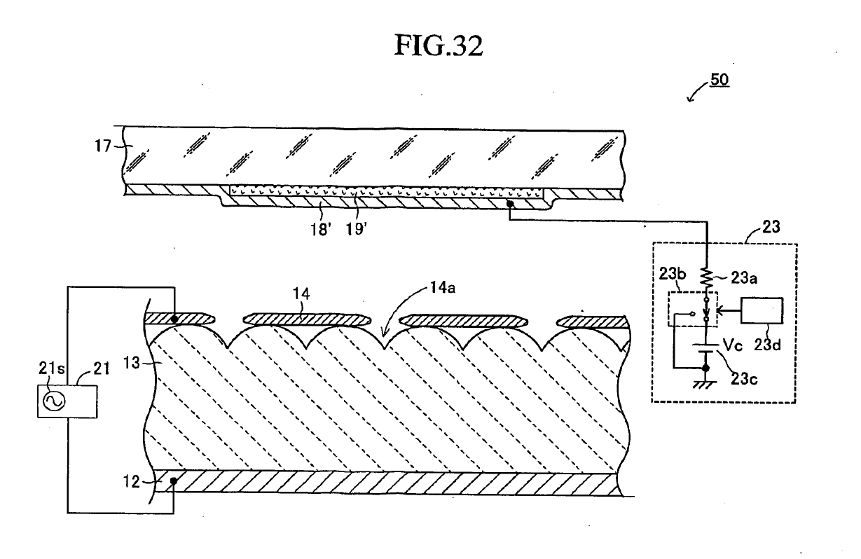

An electron-emitting apparatus 50 according to an eighth embodiment of the present invention will now be described with reference to FIG. 32. The electron-emitting apparatus 50 differs from the electron-emitting apparatus 10 only in that the collector electrode 18 and the phosphors 19 of the electron-emitting apparatus 10 are replaced with a collector electrode 18′ and phosphors 19′. Thus, the description below mainly concerns this difference.

In the electron-emitting apparatus 50, a phosphor 19′ is disposed on the back surface (the surface facing the upper electrode 14) of the transparent plate 17, and a collector electrode 18′ is disposed to cover the phosphor 19′. The collector electrode 18′ has a thickness that allows electrons emitted from the emitter section 13 through the micro through holes 14a in the upper electrode 14 to travel through (penetrate) the collector electrode 18′. The thickness of the collector electrode 18′ is preferably 100 nm or less. The thickness of the collector electrode 18′ can be larger as the kinetic energy of the emitted electrons is higher.

The configuration of this embodiment is typically employed in cathode ray tubes (CRTs). The collector electrode 18′ functions as a metal back. The electrons emitted from the emitter section 13 through the micro through holes 14a in the upper electrode 14 travel through the collector electrode 18′, enter the phosphor 19′, and excites the phosphor 19′, thereby allowing light emission. The advantages of the electron-emitting apparatus 50 are as follows:

(a) When the phosphor 19′ is not electrically conductive, electrification (negative charging) of the phosphor 19′ can be avoided. Thus, the electric field that accelerates electrons can be maintained.

(b) Since the collector electrode 18′ reflects light generated by the phosphor 19′, the light can be emitted toward the transparent plate 17 side (the emission surface side) with higher efficiency.

(c) Since collision of excessive electrons on the phosphor 19′ can be avoided, deterioration of the phosphor 19′ and the generation of gas from the phosphor 19′ can be avoided.

Materials of Constituent Components and Production Examples

The materials of the constituent components of the individual electron-emitting apparatuses described above and the method for producing the constituent components will now be described.

Lower Electrode 12

The lower electrode is composed of an electrically conductive material as described above. Examples of the preferable materials for the lower electrode are as follows:

(1) Conductors resistant to high-temperature oxidizing atmosphere (e.g., elemental metals or alloys)

Examples: high-melting-point noble metals such as platinum, iridium, palladium, rhodium, and molybdenum

Examples: materials mainly composed of a silver-palladium alloy, a silver-platinum alloy, or a platinum-palladium alloy

(2) Mixtures of ceramics having electrical isolation and being resistant to high-temperature oxidizing atmosphere and elemental metals

Example: a cermet material of platinum and a ceramic

(3) Mixtures of ceramics having electrical isolation and being resistant to high-temperature oxidizing atmosphere and alloys

(4) Carbon-based or graphite-based materials

Of these, elemental platinum and materials mainly composed of platinum alloys are particularly preferable. When a ceramic material is added to the electrode material, it is preferable to use 5 to 30 percent by volume of the ceramic material. Materials similar to those of the upper electrode 14 described below are also usable. The lower electrode is preferably formed by a thick-film forming process. The thickness of the lower electrode is preferably 20 μm or less and most preferably 5 μm or less.

Emitter Section 13

The dielectric material that constitutes the emitter section may be a dielectric material having a relatively high relative dielectric constant (for example, a relative dielectric constant of 1,000 or higher) or a ferroelectric material. Examples of the preferable material for the emitter section are as follows:

(1) Barium titanate, lead zirconate, lead magnesium niobate, lead nickel niobate, lead zinc niobate, lead manganese niobate, lead magnesium tantalate, lead nickel tantalate, lead antimony stannate, lead titanate, lead magnesium tungstate, and lead cobalt niobate

(2) Ceramics containing any combination of the substances listed in (1) above

(3) Ceramics described in (2) further containing an oxide of lanthanum, calcium, strontium, molybdenum, tungsten, barium, niobium, zinc, nickel, or manganese; ceramics described In (2) further containing any combination of the oxides described above; and ceramics described in (2) further containing other compounds

(4) Materials mainly containing 50% or more of the materials listed in (1) above

It Is noted that, for example, a two-component system containing lead magnesium niobate (PMN) and lead titanate (PT), i.e., nPMN-mPT (n and m represent molar ratios), can exhibit a decreased Curie point and a large relative dielectric constant at room temperature by increasing the molar ratio of the PMN. In particular, nPMN-mPT having n of 0.85 to 1.0 and m of 1.0-n exhibits a relative dielectric constant of 3,000 or higher and is thus particularly preferable as the material for the emitter section. For example, the nPMN-mPT having n of 0.91 and m of 0.09 exhibits a relative dielectric constant of 15,000 at room temperature. The nPMN-mPT having n of 0.95 and m of 0.05 exhibits a relative dielectric constant of 20,000 at room temperature.

Furthermore, a three-component system containing lead magnesium niobate (PMN), lead titanate (PT), and lead zirconate (PZ), i.e., PMN-PT-PZ, can exhibit a high relative dielectric constant by increasing the molar ratio of PMN. In this three-component system, the relative dielectric constant can be increased by adjusting the composition to near the morphotropic phase boundary (MPB) between the tetragonal and pseudocubic phases or between the tetragonal and rhombohedral phases.

For example, PMN:PT:PZ of 0.375:0.375:0.25 yields a relative dielectric constant of 5,500, and PMN:PT:PZ of 0.5:0.375:0.125 yields a relative dielectric constant of 4,500. These compositions are particularly preferable as the material for the emitter section.

Furthermore, a metal, such as platinum, may be added to the dielectric material to improve the dielectric constant so long as the insulating ability can be ensured. For example, 20 percent by weight of platinum may be added to the dielectric material.

A piezoelectric/electrostrictive layer or an antiferroelectric layer may be used as the emitter section. When the emitter section is a piezoelectric/electrostrictive layer, the piezoelectric/electrostrictive layer may be composed of a ceramic containing lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstate, lead cobalt niobate, or any combination of these.

Obviously, the emitter section may be composed of a material containing 50 percent by weight or more of the above-described compound as the main component. Of the ceramics described above, a ceramic containing lead zirconate is most frequently used as the constituent material for the piezoelectric/electrostrictive layer that serves as the emitter section.

When the piezoelectric/electrostrictive layer is formed using a ceramic, the ceramic may further contain an oxide of lanthanum, calcium, strontium, molybdenum, tungsten, barium, niobium, zinc, nickel, or manganese, or any combination of these oxides, or other compounds. The ceramic described above may further contain SiO₂, CeO₂, Pb₅Ge₃O₁₁, or any combination of these. In particular, a PT-PZ-PMN-based piezoelectric material containing 0.2 percent by weight of SiO₂, 0.1 percent by weight of CeO₂, or 1 to 2 percent by weight of Pb₅Ge₃O₁₁ is preferable.

In detail, for example, a ceramic mainly composed of lead magnesium niobate, lead zirconate, and lead titanate, and containing lanthanum or strontium in addition to these Is particularly preferable.

The piezoelectric/electrostrictive layer may be dense or porous. When the piezoelectric/electrostrictive layer is porous, the void ratio is preferably 40% or less.

When an antiferroelectric layer is used as the emitter section 13, the antiferroelectric layer preferably contains lead zirconate as a main component, lead zirconate and lead stannate as main components, lead zirconate containing lanthanum oxide as an additive, or a lead zirconate and lead stannate containing lead niobate as an additive.

The antiferroelectric layer may be porous. When the antiferroelectric layer is porous, the void ratio thereof is preferably 30% or less.

In particular, strontium tantalate bismuthate (SrBi₂Ta₂O₉), which undergoes low fatigue by repeated polarization reversal, is suitable for the emitter section. The material exhibiting low fatigue is a laminar ferroelectric compound represented by general formula (BiO₂)²⁺(Amₘ₋₁BₘO₃ₘ₊₁)²⁻. In the formula, the ions of the metal A are Ca²⁺, Sr²⁺, Ba²⁺, Pb²⁺, Bi³⁺, La³⁺, or the like, and the ions of the metal B are Ti⁴⁺, Ta⁵⁺, Nb⁵⁺, or the like. Alternatively, a piezoelectric ceramic based on barium titanate, lead zirconate, or PZT may be combined with an additive to impart semiconductive properties to the ceramic. In such a case, since the emitter section 13 has an uneven electric field distribution, it becomes possible to concentrate the electric field near the interface with the upper electrode that contributes to electron emission.

The baking temperature of the emitter section 13 can be decreased by adding a glass component, such as lead borosilicate glass, or a low-melting-point compound (such as bismuth oxide) other than the glass component to the piezoelectric/electrostrictive/antiferroelectric ceramic.

In forming the emitter section with the piezoelectric/electrostrictive/antiferroelectric ceramic, the emitter section may be formed from a molded sheet, a laminated sheet, or a composite of the molded sheet or the laminated sheet stacked or bonded on a supporting substrate.

An emitter section that is hardly damaged by collision of electrons or ions can be produced by using a material having a high melting point or a high evaporation temperature, e.g., a non-lead material, for the emitter section.

The emitter section may be formed by various thick-film forming processes, such as a screen printing process, a dipping process, an application process, an electrophoresis process, and an aerosol deposition process; or by various thin-film forming processes, such as an ion-beam process, a sputtering process, a vacuum deposition process, an ion-plating process, a chemical vapor deposition (CVD) process, and a plating process. In particular, a powdered piezoelectric/electrostrictive material may be molded to form the emitter section, and the molded emitter section may be impregnated with a low-melting-point glass or sol particles to form a film at a temperature as low as 700° C. or 600° C. or less.

Upper Electrode 14

An organometal paste that can produce a thin film by baking is used to form the upper electrode. An example of the organometal paste is a platinum resinate paste. The upper electrode is preferably composed of an oxide that can decrease the fatigue due to polarization reversal or a platinum resinate paste containing an oxide for decreasing the fatigue by polarization reversal. Examples of the oxide that decreases the fatigue by polarization reversal include ruthenium oxide (RuO₂), iridium oxide (IrO₂), strontium ruthenate (SrRuO₃), La₁₋ₓSrₓCoO₃ (e.g., x=0.3 or 0.5), La₁₋ₓCaₓMnO₃ (e.g., x=0.2), and La₁₋ₓCaₓMn_{1-y}Co_{y}O₃ (e.g., x=0.2, y=0.05).

It is also preferable to use an aggregate of scale-like substances, such as graphite, or an aggregate of conductive substances containing scale-like substances to form the upper electrode. Since such an aggregate has gaps between scales, the gaps can serve as the micro through holes in the upper electrode, and thus no baking process is needed to form the upper electrode. Alternatively, an organic resin and a metal thin film may be sequentially stacked on the emitter section and baked to burn off the organic resin and to thereby form micro through holes in the metal thin film, which serves as the upper electrode.

The upper electrode may be formed by various thick-film forming processes, such as a screen printing process, a spraying process, a coating process, a dipping process, an application process, and an electrophoresis process; or by various-thin-film forming processes, such as a sputtering process, an ion-beam process, a vacuum deposition process, an ion-plating process, a chemical vapor deposition (CVD) process, and a plating process.

As is described above, the electron-emitting apparatus of the present invention adequately controls the voltage (drive voltage) generated from the power supply and the constant of the circuit for applying the drive voltage. Thus, unnecessary electron emission can be avoided.

By increasing the voltage (drive voltage Vin) generated either gradually or stepwise-like as described above, the polarization reversal and the electron emission are performed while the difference between the drive voltage Vin and the element voltage Vka is small, Thus, power consumption (generation of joule heat) in and by the resistor components in the element and and the circuit resistors near the elements can be decreased. As a result, the element is not heated, and the thus, properties of the emitter section can be prevented from being changed by the heat. Since the element temperature does not increase, evaporation of the materials adhering onto the element can be avoided. This prevents generation of plasma, and thus, It is possible to avoid excessive electron emission (intense light emission) and damage on the element by ion bombardment.

Each electron-emitting apparatus described above turns off the collector electrode when there is a possibility of occurrence of unnecessary electron emission and turns on the collector electrode when electron emission (proper electron emission) is necessary. Thus, the electron-emitting apparatus can impart sufficient energy to electrons regularly and properly emitted while avoiding unnecessary electron emission, and provides a display that can present satisfactory images. Moreover, even when the space between the upper electrode 14 and the collector electrode 18 enters a plasma state, the plasma can be eliminated since the collector electrode 18 is intermittently turned off. As a result, continuous generation of intense emission due to a continuing plasma state can be avoided.

Since the focusing electrode is provided so that emitted electrons substantially travel in the upward direction of the upper electrode, the distance between the upper electrode and the collector electrode can be increased. Thus, dielectric breakdown between the upper electrode and the collector electrode can be reduced or prevented. Because the possibility of dielectric breakdown between the upper electrode and the collector electrode is low, the first collector voltage V1 (Vc) applied to the collector electrode 18 during the period in which the collector electrode 18 is turned on can be increased. Thus, large energy can be imparted to the electrons reaching the phosphors, and the luminance of the display can be thereby increased.

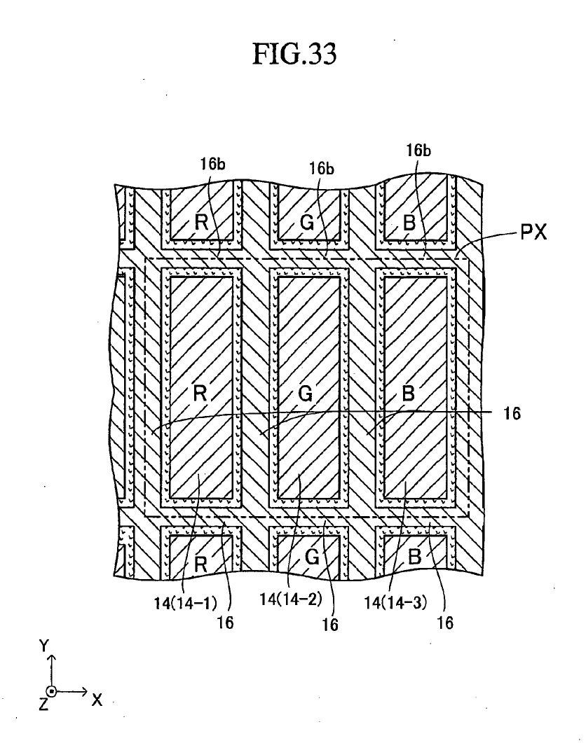

Note that the present invention is not limited to the embodiments described above and various other modifications and alternations are possible without departing from the scope of the invention. For example, as shown in FIG. 33, the focusing electrodes 16 may be formed not only between the upper electrodes 14 adjacent to each other In the X-axis direction but also between the upper electrodes 14 adjacent to each other in the Y-axis direction in a plan view.

According to this arrangement, electrons emitted from the upper electrode 14 of a particular element do not reach the phosphor disposed above the upper electrode 14 of an adjacent element. Thus, color purity can be satisfactorily maintained. In this example, the focusing electrodes 16 are also disposed between the upper electrodes 14 of the elements adjacent to each other in the Y-axis direction. Thus, electrons emitted from the upper electrode 14 of a particular upper electrode 14 do not reach the phosphor disposed above the adjacent upper electrode 14. Thus, blurring of image patterns can be prevented.

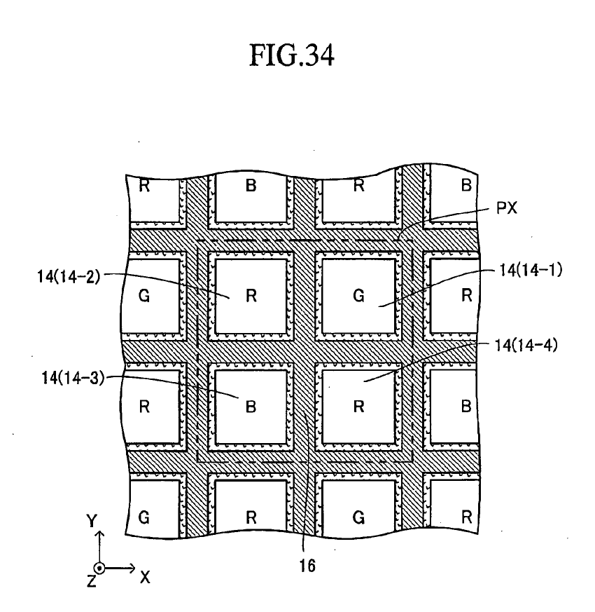

Referring to FIG. 34, the electron-emitting apparatus may have one pixel PX including four elements (a first upper electrode 14-1, a second upper electrode 14-2, a third upper electrode 14-3, and a fourth upper electrode 14-4), and focusing electrodes 16. In such a case, for example, a green phosphor (not shown) is disposed directly above the first upper electrode 14-1, a red phosphor (not shown) is disposed directly above each of the second upper electrode 14-2 and the fourth upper electrode 14-4, and a blue phosphor (not shown) is disposed directly above the third upper electrode 14-3. The focusing electrodes 16 are formed to surround each of the upper electrodes 14. With this arrangement, electrons emitted from the upper electrode 14 of a particular element reach only the phosphor disposed directly above the upper electrode 14. Thus, satisfactory color purity can be maintained, and blurring of the image patterns can be prevented.

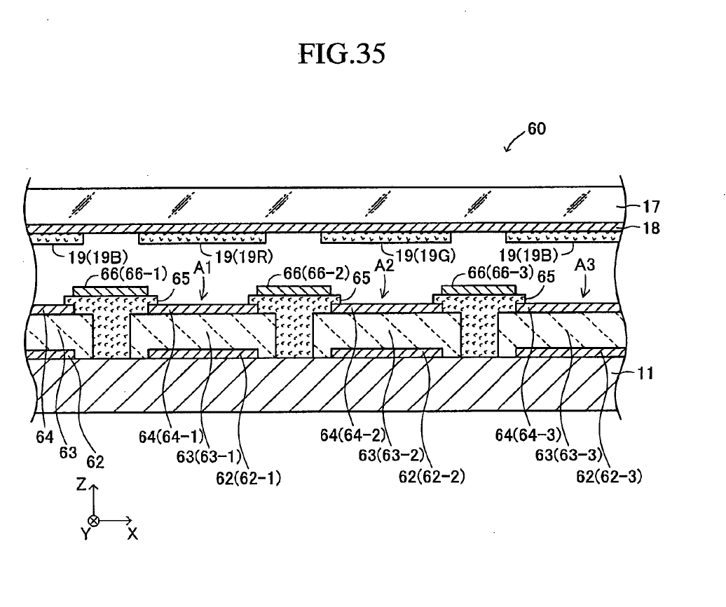

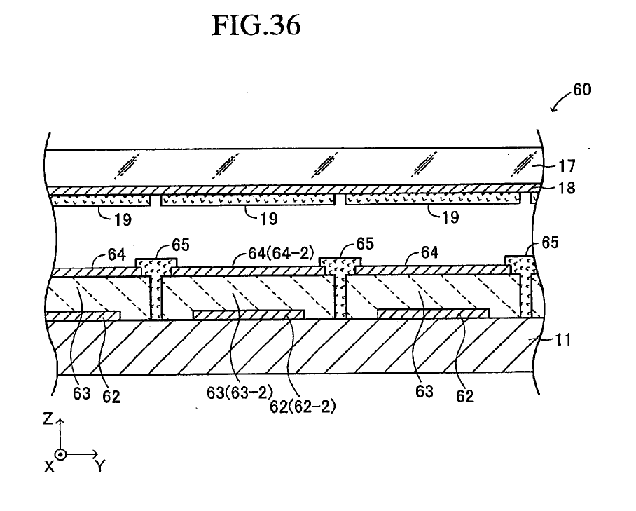

FIGS. 35 and 36 show another electron-emitting apparatus 60 according to the present invention. The electron-emitting apparatus 60 may include a plurality of completely independent elements aligned on the substrate 11, each element including a lower electrode 62, an emitter section 63, and an upper electrode 64. In this apparatus, the gaps between the elements may be filled with insulators 65, and focusing electrodes 66 may be disposed on the upper surfaces of the insulators 65 between the upper electrodes 64 adjacent to each other in the X-axis direction.

In this electron-emitting apparatus 60, electrons can be emitted from the elements either simultaneously or at independent timings. Thus, an independent collector electrode may be disposed above the upper electrode 64 of the corresponding element, and the collector voltage applying circuit may turn off or on the collector electrode based on the status of the element corresponding to the collector electrode.

Time-varying voltage Vs(t) may be applied to the focusing electrodes 16 (66). In such a case, for example, a larger negative voltage may be applied to the focusing electrode 16 during the charge accumulation period Td than in the emission period Th so that unnecessary electron emission can be more securely suppressed during the charge accumulation period Td.

Moreover, the focusing electrode 16 may be maintained in the floating state during the charge accumulation period Td, and a predetermined potential may be applied to the focusing electrode 16 during the emission period Th. In this way, generation of transient current resulting from capacity coupling between the focusing electrode 16 and the upper electrode 14 or between the focusing electrode 16 and the lower electrode 12 can be avoided, and thus, unnecessary power consumption can be avoided.

The substrate 11 may be composed of a material primarily composed of aluminum oxide or a material primarily composed of a mixture of aluminum oxide and zirconium oxide.

Furthermore, various other experiments were conducted on the electron-emitting apparatus. The experiments found that by reducing the rising time Tᵣᵢₛₑ (the time required for the drive voltage Vin at the first voltage Vm, which is the negative predetermined voltage for electron accumulation, to reach the second voltage Vp, which is the positive predetermined voltage for electron emission), the amount of electrons emitted properly from the electron-emitting element can be increased. The meaning of “reducing the rising time Tᵣᵢₛₑ of the drive voltage Vin” is that the rate α of change in drive voltage Vin, i.e., dVin/dt or inclination, is increased.

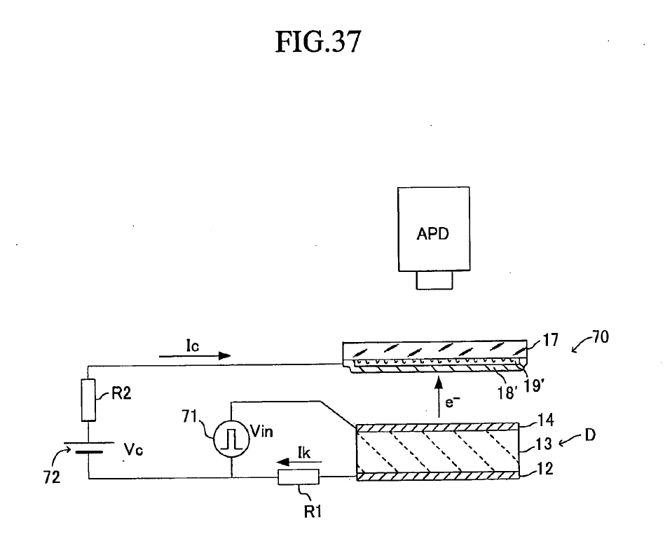

FIG. 37 is a schematic diagram showing a measurement circuit used for studying the relationship between the rising time Tᵣᵢₛₑ of the drive voltage Vin and the amount of electrons emitted. In this measurement circuit, an electron-emitting apparatus 70 is used. As with the electron-emitting apparatus 40 shown in FIG. 30, the electron-emitting apparatus 70 has an electron-emitting element including the lower electrode 12, the emitter section 13, and the upper electrode 14. Above the upper electrode-side of the element D, the collector electrode 18′, the phosphor 19′, and the transparent plate 17 of the electron-emitting apparatus 50 shown in FIG. 32 are disposed facing the upper electrode 14.

The lower electrode 12 is connected to a terminal of a power supply (drive voltage applying circuit) 71 via a first resistor R1 and to the negative electrode of a constant voltage source 72 for applying the collector voltage Vc also via the first resistor R1. The positive electrode of the constant voltage source 72 is connected to the collector electrode 18′ via a second resistor R2. The upper electrode 14 is connected to another terminal of the power supply 71. An avalanche photo diode (APD) is disposed above the transparent plate 17. The APD outputs a voltage Vapd corresponding to the intensity of the light output from the phosphor 19′.

As is described below, the power supply 71 generates a pulsed voltage. When electrons are emitted through the upper electrode 14 of the element D, a collector current Ic flows in the direction indicated in FIG. 37. The collector current Ic is time-integrated over one pulse cycle, the pulse being generated by the power supply 71 to determine the total amount SIc of electrons emitted in one light emission (electron emission). Similarly, the APD output voltage Vapd is time-integrated over one pulse cycle to determine the value SVapd corresponding to the intensity of light emitted in one light emission. The value SVapd is substantially in proportion to the amount of electrons emitted. Thus, by comparing the SVapd with the amount SIc of electrons emitted which is obtained by integration of the collector current Ic, one can confirm that measurement of the amount SIc of electrons emitted can be conducted properly and accurately.

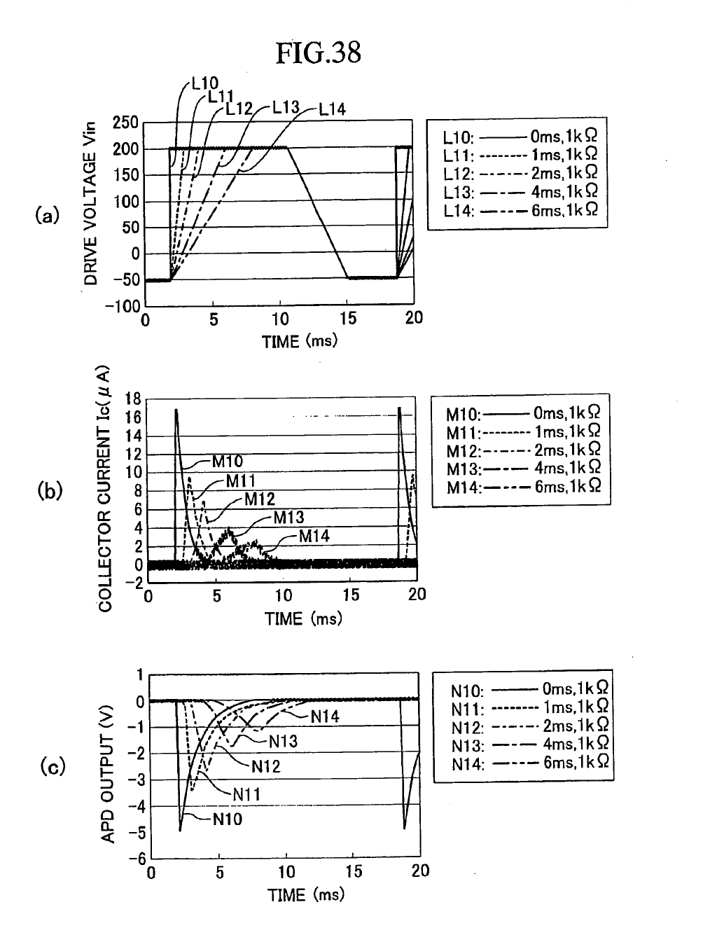

FIG. 38 includes time charts showing the observed collector current Ic and the APD output voltage Vapd while the drive voltage Vin is changed in various manners. In the measurement, the drive voltage Vin is maintained at the first voltage Vm (−50 V, the negative predetermined voltage) for a predetermined period of time, i.e., about 4 ms. During this period, electrons are accumulated in the upper portion of the emitter section 13. Subsequently, the drive voltage Vin is linearly increased toward the second voltage Vp (200 V, the positive predetermined voltage) over the rising time Tᵣᵢₛₑ. The first resistor R1 has a resistance of 1 kΩ.

In FIG. 38, a line L10 shows the drive voltage Vin with zero (ms) rising time Tᵣᵢₛₑ. A line M10 and a line N10 respectively show the collector current Ic and the APD output voltage Vapd when the drive voltage Vin indicated by the line L10 is applied to the element D. A line L11 shows the drive voltage Vin with a rising time Tᵣᵢₛₑ of 1 (ms). A line M11 and a line N11 respectively show the collector current Ic and the APD output voltage Vapd when the drive voltage Vin indicated by the line L11 is applied to the element D. Similarly, a line L12 shows the drive voltage Vin with a rising time Tᵣᵢₛₑ of 2 (ms). A line M12 and a line N12 respectively show the collector current Ic and the APD output voltage Vapd when the drive voltage Vin indicated by the line L12 is applied to the element D.

A line L13 shows the drive voltage Vin with a rising time Tᵣᵢₛₑ of 4 (ms). A line M13 and a line N13 respectively show the collector current Ic and the APD output voltage Vapd when the drive voltage Vin indicated by the line L13 is applied to the element D. A line L14 shows the drive voltage Vin with a rising time Tᵣᵢₛₑ of 6 (ms). A line M14 and a line N14 respectively show the collector current Ic and the APD output voltage Vapd when the drive voltage Vin indicated by the line L14 Is applied to the element D.

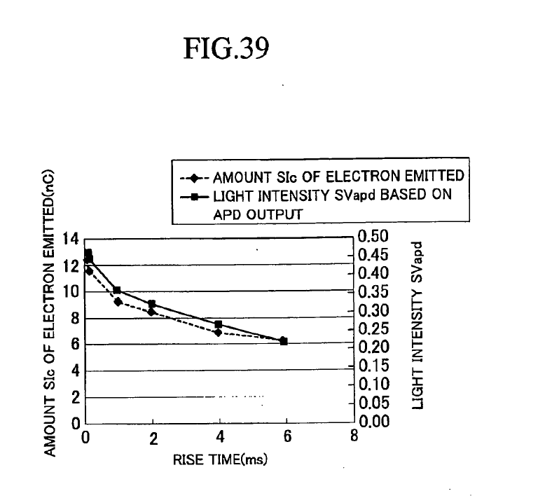

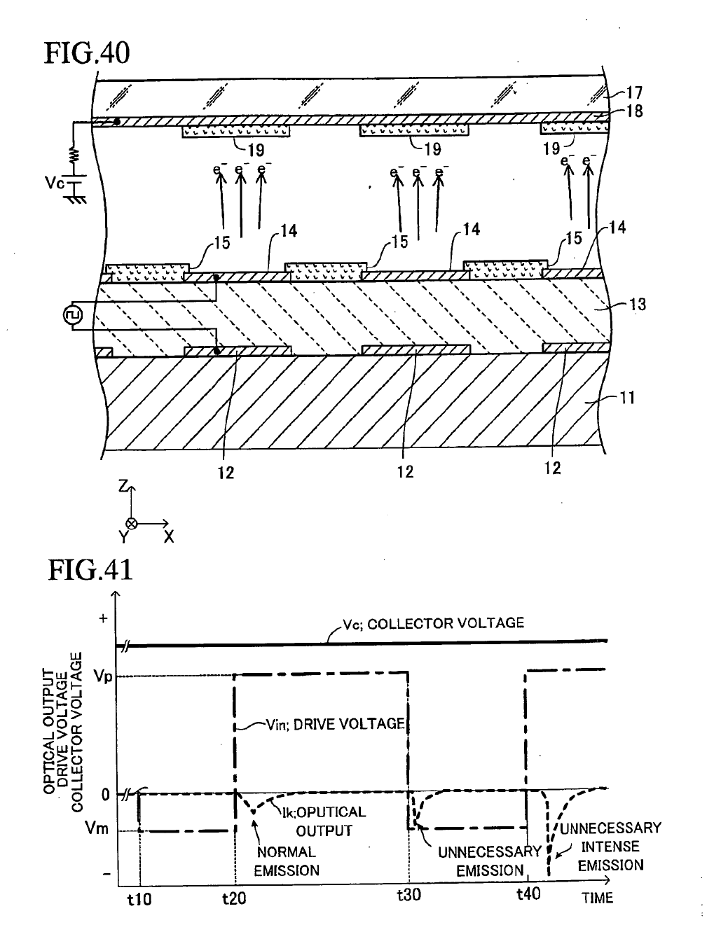

FIG. 39 is a graph showing the relationship between the amount SIc of electrons emitted and the value SVapd plotted versus the rising time Tᵣᵢₛₑ of the drive voltage Vin observed in the same measurement.

FIGS. 38 and 39 show that the amount of electrons emitted increases as the rising time Tᵣᵢₛₑ of the drive voltage Vin is shorter (i.e., as the rate α of change in drive voltage Vin is increased). The reason for this is presumably as follows.

When the first voltage Vm, i.e., the negative predetermined voltage, Is applied to the element D, electrons are accumulated in or on the surface of the emitter section 13 (electrification). When the second voltage Vp (light-ON voltage or electron emission voltage), which is the positive predetermined voltage, is subsequently applied to the element D, the dipole in the emitter section 13 becomes reversed (polarization reversal). This causes part of the electrons accumulated in or on the surface of the emitter section 13 to travel along the upper portion of the emitter section 13 (the portion in which surface resistance is generated) and to eventually be captured (collected) by the portion of the upper electrode 14 in contact with the emitter section 13. The rest of the electrons are emitted in the upward direction of the emitter section 13. In addition, some electrons emitted upward are captured (collected) by the upper electrode 14, and only the remaining electrons reach the collector electrode 18′.

On the other hand, as the rising time Tᵣᵢₛₑ of the drive voltage Vin becomes shorter, the speed of the polarization reversal becomes higher. Thus, before the accumulated electrons travel in or on the upper portion of the emitter section 13 and captured (collected) by the upper electrode 14, the electrons accumulated in the upper portion of the emitter section 13 receive rapidly increasing repulsive force from a large number of dipoles (negative poles of dipoles) that underwent rapid polarization reversal in the upper portion of the emitter section 13 and are thus emitted in the upward direction from the emitter section 13. As a result, the amount of the electrons emitted in the upward direction from the emitter section 13 increases.

Furthermore, the electrons emitted in the upward direction from the emitter section 13 are significantly accelerated due to high-speed polarization reversal. Thus, the initial speed of the electrons emitted is high. Consequently, the ratio of the electrons captured (collected) by the upper electrode 14 to the electrons emitted in the upward direction from the emitter section 13 decreases, and the ratio of the electrons emitted upward through the micro through holes in the upper electrode 14 increases.

As Is described above, as the rising time Tᵣᵢₛₑ of the drive voltage Vin is shortened, the ratio of the electrons traveling in the upper portion of the emitter section 13 and being captured (collected) by the upper electrode 14 decreases, and thus, the ratio of the electrons emitted in the upward direction from the emitter section 13 increases. Moreover, the ratio of the electrons captured (collected) by the upper electrode 14 among the electrons emitted in the upward direction from the emitter section 13 decreases. These phenomena are presumably the reasons (causes) why the amount of electrons emitted are increased. Note that when the first resistor R1 is set to 1 kΩ as above and the rising time Tᵣᵢₛₑ of the drive voltage Vin is set to 0 (ms), the actual rising time is 0.15 (ms) due to the first resistor R1. When the first resistor R1 is set to 500 Ω and the rising time Tᵣᵢₛₑ of the drive voltage Vin is set to 0 (ms), the actual rising time is 0.1 (ms). This is shorter than when the resistance of the first resistor R1 is set to 1 kΩ. As shown in FIG. 39, when the rising time Tᵣᵢₛₑ of the drive voltage Vin is set to 0 (ms), the actual rising time is shorter with the a 500 Ω first resistor R1 than with a 1 kΩ first resistor R1. Thus, the amount SIc of the electrons emitted is increased. This result is consistent with the conclusion discussed above.

1. An electron-emitting apparatus comprising:
an element including:
an emitter section composed of a dielectric material,
a lower electrode disposed below the emitter portion, and
an upper electrode that is disposed above the emitter section to oppose the lower electrode with the emitter section therebetween, the upper electrode having a plurality of micro through holes; and
drive voltage applying means including:
a power supply, and
a circuit for applying a voltage, which is generated by the power supply, between the lower electrode and the upper electrode, wherein the power supply is configured to generate a first voltage to cause an element voltage to converge on a negative predetermined voltage so that electrons are supplied from the upper electrode to the emitter section and accumulated in the emitter section, and to subsequently generate a voltage which gradually increase toward a second voltage to cause the element voltage to converge on a positive predetermined voltage so that the electrons accumulated in the emitter section are emitted from the emitter section, the element voltage being a potential difference between the lower electrode and the upper electrode with respect to a potential of the lower electrode.

2. The electron-emitting apparatus according to claim 1, wherein the power supply is configured such that, after generation of the first voltage, the power supply generates a voltage increasing from the first voltage to a third voltage so that the element voltage is caused to be an intermediate voltage between the negative predetermined voltage and the positive predetermined voltage, the intermediate voltage causing neither further electron accumulation in nor electron emission from the emitter section; and subsequently, the power supply generates a voltage increasing from the third voltage to the second voltage at a rate lower than a rate at which the voltage is increased from the first voltage to the third voltage.

3. The electron-emitting apparatus according to claim 1, wherein the power supply is configured such that, within a period from a time point at which generation of the voltage gradually increasing toward the second voltage is started to a time point at which the voltage reaches the second voltage, the power supply generates a voltage that increases at a lowest rate during a period from the time point at which the generation of the voltage gradually increasing toward the second voltage is started to a time point at which positive-side polarization reversal in the emitter section is substantially completed.

4. The electron-emitting apparatus according to claim 1, wherein the power supply is configured such that, within a period from a time point at which generation of the voltage gradually increasing toward the second voltage is started to a time point at which the voltage reaches the second voltage, the power supply generates a voltage that increases at a lowest rate during a period from a time point at which positive-side polarization reversal in the emitter section is substantially completed to the time point at which the voltage reaches the second voltage.

5. An electron-emitting apparatus comprising:
an element including:
an emitter section composed of a dielectric material,
a lower electrode disposed below the emitter portion, and
an upper electrode that is disposed above the emitter section to oppose the lower electrode with the emitter section therebetween, the upper electrode having a plurality of micro through holes; and
drive voltage applying means including:
a power supply, and
a circuit for applying a voltage, which is generated by the power supply, between the lower electrode and the upper electrode, wherein the power supply is configured to generate a second voltage to cause an element voltage to converge on a positive predetermined voltage so that electrons accumulated in the emitter section is emitted from the emitter section, and to generate subsequently a voltage which gradually decrease toward a first voltage to cause the element voltage to converge on a negative predetermined voltage so that the electrons are supplied from the upper electrode to the emitter section and accumulated in the emitter section, the element voltage being a potential difference between the lower electrode and the upper electrode with respect to a potential of the lower electrode.

6. The electron-emitting apparatus according to claim 5, wherein the power supply is configured such that, after generation of the second voltage, the power supply generates a voltage decreasing from the second voltage to a third voltage so that the element voltage is caused to be an intermediate voltage between the negative predetermined voltage and the positive predetermined voltage, the intermediate voltage causing neither electron accumulation in nor electron emission from the emitter section; and subsequently the power supply generates a voltage decreasing from the third voltage to the first voltage at a rate lower than a rate at which the voltage is decreased from the second voltage to the third voltage.

7. The electron-emitting apparatus according to claim 5, wherein the power supply is configured such that, within a period from a time point at which generation of voltage gradually decreasing toward the first voltage is started to a time point at which the voltage reaches the first voltage, the power supply generates a voltage that decreases at a lowest rate during a period from the time point at which the generation of the voltage gradually decreasing toward the first voltage is started to a time point at which negative-side polarization reversal in the emitter section is substantially completed.

8. The electron-emitting apparatus according to claim 4, wherein the power supply is configured such that, within a period from a time point at which generation of voltage gradually decreasing toward the first voltage is started to a time point at which the voltage reaches the first voltage, the power supply generates a voltage that decreases at a lowest rate during a period from a time point at which negative-side polarization reversal in the emitter section is substantially completed to the time point at which the voltage reaches the first voltage.

9. The electron-emitting apparatus according to claim 1, wherein:
the power supply is configured to repeat generation of the first voltage and the second voltage in an alternating manner, and
the drive voltage applying means includes circuit parameter setting means for setting a circuit parameter of the circuit by connecting a circuit element to the circuit, the circuit element selected from:
a first circuit element that is inserted into the circuit during a first period from a time point at which the generation of the voltage decreasing toward the first voltage is started to a time point at which the negative-side polarization reversal in the emitter section is substantially completed while the voltage is decreased,
a second circuit element that is inserted into the circuit during a second period from the time point at which the negative-side polarization reversal in the emitter section is substantially completed to a time point at which electron emission in the emitter section is completed,
a third circuit element that is inserted into the circuit during a third period from a time point at which generation of the voltage increasing toward the second voltage is started to a time point at which the positive-side polarization reversal in the emitter section is substantially completed while the voltage is increased, and
a fourth circuit element that is inserted into the circuit during a fourth period from a time point at which the positive-side polarization reversal is substantially completed to a time point at which electron emission from the emitter section is substantially completed, wherein at least two of these circuit elements are different from each other.

10. An electron-emitting apparatus comprising:
an element including:
an emitter section composed of a dielectric material,
a lower electrode disposed below the emitter portion, and
an upper electrode that is disposed above the emitter section to oppose the lower electrode with the emitter section therebetween, the upper electrode having a plurality of micro through holes; and
drive voltage applying means including:
a power supply which is configured to generate a first voltage to cause an element voltage to converge on a negative predetermined voltage so that electrons are supplied from the upper electrode to the emitter section and accumulated in the emitter section, and to subsequently generate a voltage which gradually increase toward a second voltage to cause the element voltage to converge on a positive predetermined voltage so that the electrons accumulated in the emitter section are emitted from the emitter section, the element voltage being a potential difference between the lower electrode and the upper electrode with respect to a potential of the lower electrode, and
a circuit for applying the voltage generated by the power supply between the lower electrode and the upper electrode, wherein:
the power supply is configured to repeat generation of the first voltage and the second voltage in an alternating manner, and
the drive voltage applying means includes circuit parameter setting means for setting a circuit parameter of the circuit by connecting a circuit element to the circuit, the circuit element selected from:
a first circuit element that is inserted into the circuit during a first period from a time point at which the generation of the voltage decreasing toward the first voltage is started to a time point at which the negative-side polarization reversal in the emitter section is substantially completed while the voltage is decreased,
a second circuit element that is inserted into the circuit during a second period from the time point at which the negative-side polarization reversal in the emitter section is substantially completed to a time point at which electron emission in the emitter section is completed,
a third circuit element that is inserted into the circuit during a third period from a time point at which generation of the voltage increasing toward the second voltage is started to a time point at which the positive-side polarization reversal in the emitter section is substantially completed while the voltage is increased, and
a fourth circuit element that is inserted into the circuit during a fourth period from a time point at which the positive-side polarization reversal is substantially completed to a time point at which electron emission from the emitter section is substantially completed, wherein at least two of these circuit elements are different from each other.

11. An electron-emitting apparatus comprising:
an element including:
an emitter section composed of a dielectric material,
a lower electrode disposed below the emitter portion, and
an upper electrode that is disposed above the emitter section to oppose the lower electrode with the emitter section therebetween, the upper electrode having a plurality of micro through holes; and
drive voltage applying means including:
a power supply, and
a circuit for applying a voltage, which is generated by the power supply, between the lower electrode and the upper electrode, wherein the power supply, in order to supply electrons from the upper electrode to the emitter section and to accumulate the electrons in the emitter section, is configured to generate a fourth voltage which is a negative voltage to cause polarization reversal in the emitter section, then to generate a fifth voltage, which is a negative voltage whose absolute value is smaller than the absolute value of the fourth voltage, at a time point at which the polarization reversal is substantially completed or before the completion of the polarization reversal, and then to generate a voltage which gradually decreases toward a first voltage and which is a negative voltage whose absolute value is larger than the absolute value of the fifth voltage.
